(19) United States
(12) Patent Application Publication
(10) Pub. No.: US 2021/0068161 A1
(43) Pub. Date: Mar. 4, 2021

(54) TERMINAL APPARATUS, BASE STATION APPARATUS, COMMUNICATION METHOD, AND INTEGRATED CIRCUIT

(71) Applicants: SHARP KABUSHIKI KAISHA, Sakai City, Osaka (JP); FG Innovation Company Limited, Tuen Mun, New Territories (HK)

(72) Inventors: HIROKI TAKAHASHI, Sakai City, Osaka (JP); SHOHEI YAMADA, Sakai City, Osaka (JP); HIDEKAZU TSUBOI, Sakai City, Osaka (JP); KAZUNARI YOKOMAKURA, Sakai City, Osaka (JP)

(73) Assignees: SHARP KABUSHIKI KAISHA, Sakai City, Osaka (JP); FG Innovation Company Limited, Tuen Mun, New Territories (HK); FG Innovation Company Limited, Tuen Mun, New Territories (HK)

(21) Appl. No.: 16/960,079

(22) PCT Filed: Jan. 9, 2019
(86) PCT No.: PCT/JP2019/000385

§ 371 Date: Jul. 4, 2020

(30) Foreign Application Priority Data
Jan. 9, 2018 (JP) 2018-001190

(51) Int. Cl. H04W 74/08; H04W 72/12; H04W 16/28; H04L 5/00; H04W 76/27

(52) U.S. Cl. CPC H04W 74/0833; H04W 72/12; H04W 76/27; H04L 5/0048; H04W 16/28

(57) ABSTRACT

An object of the present invention is to efficiently perform communication between a terminal apparatus and a base station apparatus. The present invention provides a terminal apparatus including: a receiver configured to receive an RRC message including information for indicating an RACH occasion corresponding to one of one or multiple CSI-RSs; and a transmitter configured to, in a case that a reference signal received power of at least one of the one or multiple CSI-RS blocks exceeds a prescribed threshold, select one of the one or multiple CSI-RS blocks with the reference signal received power exceeding the prescribed threshold, select the RACH occasion corresponding to the selected CSI-RS, and transmit a random access preamble in the selected RACH occasion.

### TECHNICAL FIELD

An aspect of the present invention relates to a terminal apparatus, a base station apparatus, a communication method, and an integrated circuit.

This application claims priority based on JP 2018-1190 filed in Japan on Jan. 9, 2018, of which the contents are incorporated herein by reference.

### BACKGROUND ART

Technical studies and standardization of Long Term Evolution (LTE)-Advanced Pro and New Radio (NR) technology, as a radio access scheme and a radio network technology for fifth generation cellular systems, are currently being conducted by The Third Generation Partnership Project (3GPP) (NPL 1).

The fifth generation cellular system requires three anticipated scenarios for services: enhanced Mobile BroadBand (eMBB) which realizes high-speed, high-capacity transmission, Ultra-Reliable and Low Latency Communication (URLLC) which realizes low-latency, high-reliability communication, and massive Machine Type Communication (mMTC) that allows a large number of machine type devices to be connected in a system such as Internet of Things (IoT).

For NR, technical studies of massive Multiple-Input Multiple-Output (MIMO), which ensures coverage by beamforming gain by using multiple antenna elements at high frequencies (NPL 2, NPL 3, NPL 4).

### CITATION LIST

### Non Patent Literature

NPL 1: RP-161214 NTT DOCOMO, “Revision of SI: Study on New Radio Access Technology”, June 2016

NPL 2: R1-162883 Nokia, Alcatel-Lucent ShanghaiBell, “Basic Principles for the 5G New Radio Access technology”, April 2016

NPL 3: R1-162380, Intel Corporation, “Overview of antenna technology for new radio interface”, April, 2016

NPL 4: R1-163215, Ericsson, “Overview of NR”, April, 2016

### SUMMARY OF INVENTION

### Technical Problem

An aspect of the present invention provides a terminal apparatus capable of efficiently communicating with a base station apparatus, a base station apparatus communicating with the terminal apparatus, a communication method used for the terminal apparatus, and a communication method used for the base station apparatus. For example, the communication methods used for the terminal apparatus and the base station apparatus may include an uplink transmission method, a modulation method, and/or a coding method for efficient communication, reduction in the complexity, and for reducing interference between cells and/or between terminal apparatuses.

### Solution to Problem

(1) According to some aspects of the present invention, the following measures are provided. Specifically, a first aspect of the present invention is a terminal apparatus including: a receiver configured to receive an RRC message including information for indicating a PDCCH order random access resource from a base station apparatus, and receive a PDCCH order from the base station apparatus; and a transmitter configured to select a random access preamble, based on information included in the PDCCH order and information for indicating the PDCCH order random access resource, select an RACH occasion, based on information included in the PDCCH order and information for indicating the PDCCH order random access resource, and transmit the selected random access preamble in the selected RACH occasion.

(2) A second aspect of the present invention is a base station apparatus for communication with a terminal apparatus, the base station including: a transmitter configured to transmit an RRC message including information for indicating a PDCCH order random access resource to the terminal apparatus, and transmit a PDCCH order to the terminal apparatus; and a receiver configured to receive a random access preamble based on information included in the PDCCH order and information for indicating the PDCCH order random access resource, in an RACH occasion based on information included in the PDCCH order and information for indicating the PDCCH order random access resource.

(3) A third aspect of the present invention is a communication method used for a terminal apparatus, the communication method including the steps of: receiving an RRC message including information for indicating a PDCCH order random access resource from a base station apparatus, and receiving a PDCCH order from the base station apparatus; and selecting a random access preamble, based on information included in the PDCCH order and information for indicating the PDCCH order random access resource, selecting an RACH occasion, based on information included in the PDCCH order and information for indicating the PDCCH order random access resource, and transmitting the selected random access preamble in the selected RACH occasion.

(4) A fourth aspect of the present invention is a communication method used for a base station apparatus, the communication method including the steps of: transmitting an RRC message including information for indicating a PDCCH order random access resource to a terminal apparatus, and transmitting a PDCCH order to the terminal apparatus; and receiving a random access preamble based on information included in the PDCCH order and information for indicating the PDCCH order random access resource, in an RACH occasion based on information included in the PDCCH order and information for indicating the PDCCH order random access resource.

(5) A fifth aspect of the present invention is an integrated circuit mounted on a terminal apparatus, the integrated circuit causing the terminal apparatus to perform: a function to receive an RRC message including information for indicating a PDCCH order random access resource from a base station apparatus, and receive a PDCCH order from the base station apparatus; and a function to select a random access preamble, based on information included in the PDCCH order and information for indicating the PDCCH order random access resource, select an RACH occasion, based on information included in the PDCCH order and information for indicating the PDCCH order random access resource, and transmit the selected random access preamble in the selected RACH occasion.

(6) A sixth aspect of the present invention is an integrated circuit mounted on a base station apparatus, the integrated circuit causing the base station apparatus to perform: a function to transmit an RRC message including information for indicating a PDCCH order random access resource to a terminal apparatus, and transmit a PDCCH order to the terminal apparatus; and a function to receive a random access preamble based on information included in the PDCCH order and information for indicating the PDCCH order random access resource, int an RACH occasion, based on information included in the PDCCH order and information for indicating the PDCCH order random access resource.

(7) A seventh aspect of the present invention is a terminal apparatus including: a receiver configured to receive an RRC message including information for indicating an RACH occasion corresponding to one of one or multiple CSI-RSs; and a transmitter configured to, in a case that a reference signal received power of at least one of the one or multiple CSI-RS blocks exceeds a prescribed threshold, select one of the one or multiple CSI-RS blocks with the reference signal received power exceeding the prescribed threshold, select the RACH occasion corresponding to the selected CSI-RS, and transmit a random access preamble in the selected RACH occasion.

(8) An eighth aspect of the present invention is a base station apparatus including: a transmitter configured to transmit an RRC message including information for indicating an RACH occasion corresponding to one of one or multiple CSI-RSs; and a receiver configured to receive a random access preamble in any one of one or multiple of the RACH occasions respectively corresponding to the one or multiple CSI-RSs included in the RRC message.

(9) A ninth aspect of the present invention is a communication method used for a terminal apparatus, the communication method including the steps of receiving an RRC message including information for indicating an RACH occasion corresponding to one of one or multiple CSI-RSs; and in a case that a reference signal received power of at least one of the one or multiple CSI-RS blocks exceeds a prescribed threshold, selecting one of the one or multiple CSI-RS blocks with the reference signal received power exceeding the prescribed threshold, selecting the RACH occasion corresponding to the selected CSI-RS, and transmitting a random access preamble in the selected RACH occasion.

(10) A tenth aspect of the present invention is a communication method used for a base station apparatus, the communication method including the steps of: transmitting an RRC message including information for indicating an RACH occasion corresponding to one of one or multiple CSI-RSs; and receiving a random access preamble in any one of one or multiple of the RACH occasions respectively corresponding to the one or multiple CSI-RSs included in the RRC message.

(11) An eleventh aspect of the present invention is an integrated circuit mounted on a terminal apparatus, the integrated circuit causing the terminal apparatus to perform: receiving an RRC message including information for indicating an RACH occasion corresponding to one of one or multiple CSI-RSs; and in a case that a reference signal received power of at least one of the one or multiple CSI-RS blocks exceeds a prescribed threshold, selecting one of the one or multiple CSI-RS blocks with the reference signal received power exceeding the prescribed threshold, selecting the RACH occasion corresponding to the selected CSI-RS, and transmitting a random access preamble in the selected RACH occasion.

(12) A twelfth aspect of the present invention is an integrated circuit mounted on a base station apparatus, the integrated circuit causing the base station apparatus to perform: transmitting an RRC message including information for indicating an RACH occasion corresponding to one of one or multiple CSI-RSs; and receiving a random access preamble in any one of one or multiple of the RACH occasions respectively corresponding to the one or multiple CSI-RSs included in the RRC message.

### Advantageous Effects of Invention

According to an aspect of the present invention, a terminal apparatus and a base station apparatus can efficiently communicate with each other and/or reduce the complexity.

### BRIEF DESCRIPTION OF DRAWINGS

FIG. 1 is a conceptual diagram of a radio communication system according to an embodiment of the present invention.

FIG. 2 is a diagram illustrating an example of a schematic configuration of a downlink slot according to an embodiment of the present invention.

FIG. 3 is a diagram illustrating a relationship between a subframe, slots, and mini-slots in the time domain according to an embodiment of the present invention.

FIG. 4 is a diagram illustrating an example of slots or subframes according to an embodiment of the present invention.

FIG. 5 is a diagram illustrating an example of beamforming according to an embodiment of the present invention.

FIG. 6 is a diagram illustrating a concept in which multiple reference signals applied to transmission beams are transmitted in one or multiple cells according to an embodiment of the present invention.

FIG. 7 is a diagram illustrating an example of SS blocks and SS burst sets according to the present embodiment according to embodiments of the present invention.

FIG. 8 is a diagram illustrating an example of an RRC parameter configuration of random access configuration information according to an embodiment of the present invention.

FIG. 9 is a diagram illustrating an example of a configuration of an RRC parameter RACH-Config-Common according to an embodiment of the present invention.

FIG. 10 is a diagram illustrating an example of an example of a configuration of an RRC parameter RACH-ConfigDedicated according to an embodiment of the present invention.

FIG. 11 is a diagram illustrating an example of a configuration of an RRC parameter RACH-Config-BFRR according to an embodiment of the present invention.

FIG. 12 is a diagram illustrating an example of a configuration of an RRC parameter RACH-Config-PDCCHorder according to an embodiment of the present invention.

FIG. 13 is a conceptual diagram of transmitting and/or receiving multiple messages between a terminal apparatus 1 and a base station apparatus 3 in a random access procedure according to an embodiment of the present invention.

FIG. 14 is a flowchart illustrating an example of a transmission process of a non-contention based random access preamble of the terminal apparatus 1 according to an embodiment of the present invention.

FIG. 15 is a flowchart illustrating an example of a reception process of a non-contention based random access preamble of the base station apparatus 3 according to an embodiment of the present invention.

FIG. 16 is a diagram illustrating an example of allocation of preamble indexes.

FIG. 17 is a schematic block diagram illustrating a configuration of the terminal apparatus 1 according to an embodiment of the present invention.

FIG. 18 is a schematic block diagram illustrating a configuration of the base station apparatus 3 according to an embodiment of the present invention.

### DESCRIPTION OF EMBODIMENTS

Embodiments of the present invention will be described below.

LTE (and LTE-Advanced Pro) and NR may be defined as different Radio Access Technologies (RATs). NR may be defined as a technology included in LTE. The present embodiment may be applied to the NR, the LTE and other RATs. Terms associated with LTE are used in the following description. However, the present invention may be applied to other technologies using other terms.

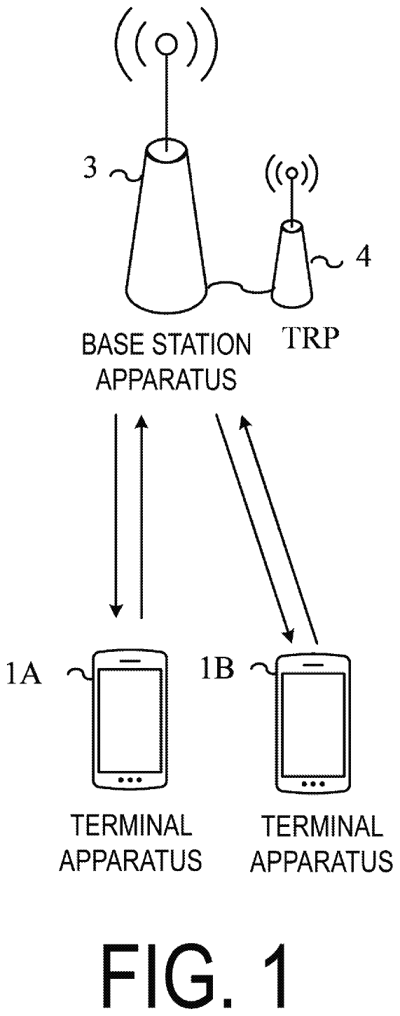

FIG. 1 is a conceptual diagram of a radio communication system according to an embodiment of the present invention. In FIG. 1, the radio communication system includes a terminal apparatus 1A, a terminal apparatus 1B, and a base station apparatus 3. The terminal apparatus 1A and the terminal apparatus 1B are also referred to as a terminal apparatus 1.

The terminal apparatus 1 may be referred to as a mobile station apparatus, a User Equipment (UE), a communication terminal, a mobile device, a terminal, a Mobile Station (MS), or the like. The base station apparatus 3 may be referred to as a radio base station apparatus, a base station, a radio base station, a fixed station, a Node B (NB), an evolved Node B (eNB), an NR Node B (NR NB), a next generation Node B (gNB), an access point, a Base Transceiver Station (BTS), a Base Station (BS), or the like. The base station apparatus 3 may include a core network apparatus. The base station apparatus 3 may include one or multiple transmission reception points (TRPS) 4. At least some of the functions/processes of the base station apparatus 3 described below may be functions/processes in each of the transmission reception points 4 included in the base station apparatus 3. The base station apparatus 3 may serve the terminal apparatus 1 with a communicable range (communication area) controlled by the base station apparatus 3 as one or multiple cells. The base station apparatus 3 may serve the terminal apparatus 1 with a communicable range (communication area) controlled by one or multiple transmission reception points 4 as one or multiple cells. One cell may be divided into multiple Beamed areas, and the terminal apparatus 1 may be served in each of the beamed areas. Here, a beamed area may be identified based on the index of the beam to be used in the beamforming, the index of the preceding, and/or other indexes.

The communication area covered by the base station apparatus 3 may be different in size and shape for each frequency. The covered area may be different for each frequency. A radio network, in which cells having different types of base station apparatuses 3 and different cell radii coexist on the same frequency or different frequencies to form one communication system, is referred to as a heterogeneous network.

A radio communication link from the base station apparatus 3 to the terminal apparatus 1 is referred to as a downlink. A radio communication link from the terminal apparatus 1 to the base station apparatus 3 is referred to as an uplink. A radio communication link from the terminal apparatus 1 to another terminal apparatus 1 is referred to as a sidelink.

In FIG. 1, Orthogonal Frequency Division Multiplexing (OFDM) including Cyclic Prefix (CP), Single-Carrier Frequency Division Multiplexing (SC-FDM), Discrete Fourier Transform Spread OFDM (DFT-S-OFDM), and Multi-Carrier Code Division Multiplexing (MC-CDM) may be employed in the radio communication between the terminal apparatus 1 and the base station apparatus 3 and/or the radio communication between the terminal apparatus 1 and another terminal apparatus 1.

In FIG. 1, in the radio communication between the terminal apparatus 1 and the base station apparatus 3 and/or the radio communication between the terminal apparatus 1 and the other terminal apparatus 1, Universal-Filtered Multi-Carrier (UFMC), Filtered OFDM (F-OFDM), OFDM in which a window is multiplied OFDM (Windowed OFDM), and Filter-Bank Multi-Carrier (FBMC) may be used.

Note that the present embodiment will be described by using an OFDM symbol with the assumption that a transmission scheme is OFDM, but use of any other transmission scheme is also included in the present invention. For example, an OFDM symbol in the present embodiment may be SC-FDM symbol (which may also be referred to as a Single-Carrier Frequency Division Multiple Access (SC-FDMA) symbol).

In FIG. 1, the aforementioned transmission scheme that uses no CP or uses zero padding instead of the CP may be employed in the radio communication between the terminal apparatus 1 and the base station apparatus 3 and/or the radio communication between the terminal apparatus 1 and the other terminal apparatus 1. The CP or zero padding may be added both forward and backward.

According to the present embodiment, one or multiple serving cells are configured for the terminal apparatus 1. The multiple serving cells to be configured include one Primary Cell (also referred to as a PCell) and one or multiple Secondary Cells (also referred to as SCells). The primary cell is a serving cell in which an initial connection establishment procedure has been performed, a serving cell in which a connection re-establishment procedure has been initiated, or a cell indicated as a primary cell during a handover procedure. One or multiple secondary cells may be configured at a point of time at the time of or after a Radio Resource Control (RRC) connection is established. However, the multiple serving cells to be configured may include one primary secondary cell (also referred to as a Primary SCell, or a PSCell). The primary secondary cell may be a secondary cell capable of transmitting control information in the uplink, among the one or multiple secondary cells configured by the terminal apparatus 1. Two types of subsets of serving cells including a Master Cell Group (also referred to as an MCG) and a Secondary Cell Group (also referred to as an SCG) may be configured for the terminal apparatus 1. The master cell group includes one primary cell and zero or more secondary cells. The secondary cell group includes one primary secondary cell and zero or more secondary cells.

Time Division Duplex (TDD) and/or Frequency Division Duplex (FDD) may be applied to the radio communication system according to the present embodiment. The Time Division Duplex (TDD) scheme or the Frequency Division Duplex (FDD) scheme may be applied to all of the multiple cells. Cells to which the TDD scheme is applied and cells to which the FDD scheme is applied may be aggregated.

A carrier corresponding to a serving cell in the downlink is referred to as a downlink component carrier (or a downlink carrier). A carrier corresponding to a serving cell in the uplink is referred to as an uplink component carrier (or an uplink carrier). A carrier corresponding to a serving cell in the sidelink is referred to as a sidelink component carrier (or a sidelink carrier). The downlink component carrier, the uplink component carrier, and/or the sidelink component carrier are collectively referred to as a component carrier (or a carrier).

Physical channels and physical signals according to the present embodiment will be described. However, the downlink physical channels and/or the downlink physical signals may be collectively referred to as downlink signals. The uplink physical channels and/or the uplink physical signals may be collectively referred to as uplink signals. The downlink physical channels and/or the uplink physical channels may be collectively referred to as physical channels. The downlink physical signals and/or the uplink physical signals may be collectively referred to as physical signals.

In FIG. 1, in downlink radio communication between the terminal apparatus 1 and the base station apparatus 3, the following downlink physical channels are used. The downlink physical channels are used for transmitting information output from the higher layer.
New Radio Physical Broadcast CHannel (NR-PBCH)
New Radio Physical Downlink Control CHannel (NR-PDCCH)
New Radio Physical Downlink Shared CHannel (NR-PDSCH)

The NR-PBCH is used for the base station apparatus 3 to broadcast an important information block (Master information Block (MIB), Essential information Block (EIB)) including important system information (Essential information) required by the terminal apparatus 1. Here, one or multiple important information blocks may be transmitted as important information messages. For example, the important information block may include information for indicating some or all of the frame numbers (System Frame Numbers (SFN)) (for example, information related to a position in a superframe including multiple frames). For example, a radio frame (10 ms) includes 10 subframes of 1 ms, and a radio frame is identified by a frame number. The frame number returns to 0 at 1024 (Wrap around). In a case that multiple important information blocks associated with different indexes are transmitted at different times (for example, times in which the downlink transmission beam to be applied is different), each important information block may include information capable of identifying the index. In a case that multiple important information blocks are transmitted in the radio frame, information capable of identifying a time position within the frame (for example, the symbol number and/or the subframe number in which the important information block is included) may be included. For example, the important information block may include information for determining each of the symbol numbers and/or the subframe numbers in which each of the transmissions of the important information blocks are performed for which different downlink transmission beams are used. For example, information necessary for connection to the cell and for mobility may be included in the important information.

In the downlink radio communication (the radio communication from the base station apparatus 3 to the terminal apparatus 1), the NR-PDCCH (which may be referred to as the PDCCH) is used to transmit the Downlink Control Information (DCI). Here, one or multiple pieces of DCI (which may be referred to as DCI formats) are defined for transmission of the downlink control information. In other words, a field for the downlink control information is defined as DCI and is mapped to information bits.

For example, as the DCI, the DCI may be defined to include information for indicating a timing for transmitting the HARQ-ACK with respect to a scheduled NR-PDSCH (for example, the number of symbols from the last symbol included in the NR-PDSCH to the symbol for transmission of the HARQ-ACK).

For example, as the DCI, the DCI may be defined to be used for the scheduling of a single downlink radio communication NR-PDSCH in a single cell (transmission of a single downlink transport block).

For example, as the DCI, the DCI may be defined to be used for the scheduling of a single uplink radio communication NR-PUSCH in a single cell (transmission of a single uplink transport block).

Here, the DCI includes information related to the scheduling of the NR-PDSCH or the NR-PUSCH. Here, the DCI for the downlink is also referred to as a downlink grant or a downlink assignment. Here, the DCI for the uplink is also referred to as an uplink grant or an Uplink assignment.

The NR-PDSCH (which may be referred to as the PDSCH) is used for the transmission of downlink data (Downlink Shared CHannel (DL-SCH)) from a medium access (Medium Access Control (MAC)). The NR-PDSCH is also used for the transmission of the System Information (SI), a Random Access Response (PAR), and the like.

Here, the base station apparatus 3 and the terminal apparatus 1 exchange (transmit and/or receive) signals with each other in higher layers. For example, the base station apparatus 3 and the terminal apparatus 1 may transmit and/or receive Radio Resource Control (RRC) signaling (also referred to as a Radio Resource Control (RRC) message or Radio Resource Control (RRC) information) in the Radio Resource Control (RRC) layer. The base station apparatus 3 and the terminal apparatus 1 may transmit and/or receive a Medium Access Control (MAC) control element in the Medium Access Control (MAC) layer. Here, the RRC signaling and/or the MAC control element is also referred to as higher layer signaling. Here, the higher layer means a higher layer viewed from a physical layer, and thus may include one or multiple of a MAC layer, an RRC layer, an RLC layer, a PDCP layer, a NAS layer, and the like. For example, in the MAC layer processing, the higher layer may include one or multiple of the RRC layer, the RLC layer, the PDCP layer, the NAS layer, or the like.

The NR-PDSCH may be used for transmitting the RRC signaling and the MAC control element (Medium Access Control Control Element (MAC CE)). Here, the RRC signaling transmitted from the base station apparatus 3 may be signaling common to multiple terminal apparatuses 1 in a cell. The RRC signaling transmitted from the base station apparatus 3 may be signaling dedicated to a certain terminal apparatus 1 (also referred to as dedicated signaling). In other words, terminal apparatus-specific (UE-specific) information may be transmitted through signaling dedicated to the certain terminal apparatus 1.

In FIG. 1, the following downlink physical signals are used in the downlink radio communication. Here, the downlink physical signals are not used to transmit information output from the higher layers but are used by the physical layer.
Synchronization Signal (SS)
Reference Signal (RS)

The synchronization signal is used for the terminal apparatus 1 to establish synchronization in the frequency domain and the time domain in the downlink. The synchronization signal may include a Primary Synchronization Signal (PSS) and a Secondary Synchronization Signal (SSS). The synchronization signal may be used for the terminal apparatus 1 to identify a Cell Identifier (cell ID). The synchronization signal may also be used to select/identify/determine a downlink transmission beam to be used by the base station apparatus 3 for downlink beamforming, and/or a downlink reception beam to be used by the terminal apparatus 1. In other words, the synchronization signal may be used to allow the terminal apparatus 1 to select/identify/determine an index of the downlink transmission beam applied to the downlink signal by the base station apparatus 3. However, the synchronization signal, the primary synchronization signal, and the secondary synchronization signal used in NR may be referred to as an NR-SS, an NR-PSS, and an NR-SSS, respectively.

The downlink reference signal (hereinafter, also simply referred to as a reference signal in the present embodiment) may be classified into multiple reference signals, based on applications or the like. For example, one or multiple of the following reference signals may be used for the reference signal.
Demodulation Reference Signal (DMRS)
Channel State Information Reference Signal (CSI-RS)
Phrase Tracking Reference Signal (PTRS)
Mobility Reference Signal (MRS)

The DMRS may be used for channel compensation during demodulation of the received modulation signal. The DMRS may collectively refer to the DMRS for demodulation of the NR-PDSCH, for demodulation of the NR-PDCCH, and/or for demodulation of the NR-PBCH, or may be individually defined.

The CSI-RS may be used for channel state measurement. The PTRS may be used to track phase according to movement of the terminal or the like. The MRS may be used to measure quality of reception from multiple base station apparatuses for handover.

The reference signal may be defined as a reference signal for compensating for phase noise.

However, for at least some functions of the multiple reference signals, other reference signals may have the function.

At least one of the multiple reference signals or other reference signal may be defined as a Cell-specific reference signal (CRS) configured individually for the cell, a Beam-specific reference signal (BRS) for each transmission beam used by the base station apparatus 3 or the transmission reception point 4, and/or a UE-specific reference signal (URS) configured individually for the terminal apparatus 1.

At least one of the reference signals may be used for a numerology such as a radio parameter or subcarrier spacing, or used for Fine synchronization that allows FFT window synchronization to be achieved.

At least one of the reference signals may also be used for Radio Resource Measurement (RRM). At least one of the reference signals may also be used for beam management.

A synchronization signal may be used for at least one of the reference signals.

In FIG. 1, in the uplink radio communication between the terminal apparatus 1 and the base station apparatus 3 (radio communication from the terminal apparatus 1 to the base station apparatus 3), the following uplink physical channels are used. The uplink physical channels are used for transmitting information output from a higher layer.
New Radio Physical Uplink Control CHannel (NR-PUCCH)
New Radio Physical Uplink Shared CHannel (NR-PUSCH)
New Radio Physical Random Access CHannel (NR-PRACH)

The NR-PUCCH (which may be referred to as the PUCCH) is used to transmit Uplink Control Information (UCI). Here, the uplink control information may include Channel State Information (CSI) used to indicate a downlink channel state. The uplink control information may include Scheduling Request (SR) used to request an UL-SCH resource. The uplink control information may include a Hybrid Automatic Repeat request ACKnowledgement (HARQ-ACK). The HARQ-ACK may indicate a HARQ-ACK for downlink data (Transport block, Medium Access Control Protocol Data Unit (MAC PDU), or Downlink-Shared Channel (DL-SCH)).

The NR-PUSCH (which may be referred to as the PUSCH) is used for the transmission of uplink data (Uplink Shared CHannel (UL-SCH)) from the medium access (Medium Access Control (MAC)). The NR-PUSCH may be used to transmit the HARQ-ACK and/or CSI together with the uplink data. The NR-PUSCH may be used to transmit the CSI only or the HARQ-ACK and the CSI only. In other words, the NR-PUSCH may be used to transmit the UCI only.

The NR-PUSCH may be used to transmit the RRC signaling and the MAC control element. Here, the NR-PUSCH may be used to transmit the UE Capability in the uplink.

Note that the same designation (for example, the NR-PCCH) and the same channel definition may be used for the NR-PDCCH and the NR-PUCCH. The same designation (for example, the NR-PSCH) and the same channel definition may be used for the NR-PDSCH and the NR-PUSCH.

In FIG. 1, the following uplink physical signal is used in the uplink radio communication. Here, the uplink physical signal is not used to transmit information output from the higher layers but is used by the physical layer.
Uplink Reference Signal (UL RS)

According to the present embodiment, the following two types of uplink reference signals are used.
Demodulation Reference Signal (DMRS)
Sounding Reference Signal (SRS)

The base station apparatus 3 uses the DMRS in order to perform channel compensation of the NR-PUSCH or the NR-PUCCH. Transmission of both of the NR-PUSCH and the DMRS is hereinafter referred to simply as transmission of the NR-PUSCH. Transmission of both of the NR-PUCCH and the DMRS is hereinafter referred to simply as transmission of the NR-PUCCH.

The base station apparatus 3 uses the SRS in order to measure an uplink channel state.

The NR-PRACH (which may be referred to as the PRACH) may be used to transmit a random access preamble. The NR-PRACH may be used for indicating the initial connection establishment procedure, the handover procedure, the connection re-establishment procedure, synchronization (timing adjustment) for uplink transmission, and a request for a NR-PUSCH (UL-SCH) resource.

The subframe will now be described. The subframe in the present embodiment may also be referred to as a resource unit, a radio frame, a time period, or a time interval.

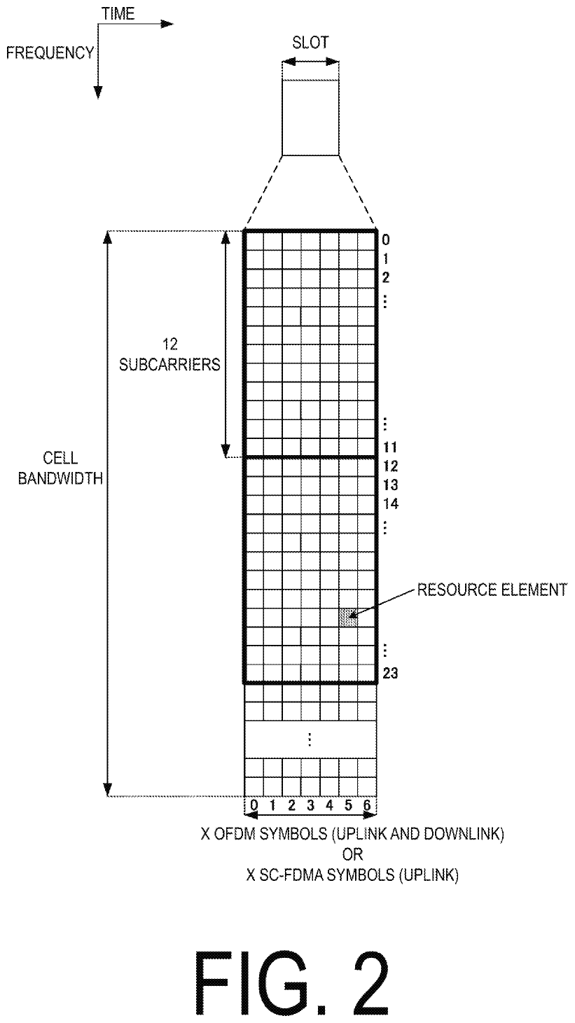

FIG. 2 is a diagram illustrating an example of a schematic configuration of a downlink slot according to an embodiment of the present invention. Each of the radio frames is 10 ms in length. Each of the radio frames includes 10 subframes and X slots. In other words, the length of one subframe is 1 ms. For each of the slots, time length is defined based on subcarrier spacings. For example, in a case that the subcarrier spacing of an OFDM symbol is 15 kHz and Normal Cyclic Prefixes (NCPs) are used, X=7 or X=14, and X=7 and X=14 correspond to 0.5 ms and 1 ms, respectively. In a case that the subcarrier spacing is 60 kHz, X=7 or X=14, and X=7 and X=14 correspond to 0.125 ms and 0.25 ms, respectively. FIG. 2 illustrates a case of X=7 as an example. Note that a case of X=14 can be similarly configured by expanding the case of X=7. The uplink slot is defined similarly, and the downlink slot and the uplink slot may be defined separately.

The signal or the physical channel transmitted in each of the slots may be represented by a resource grid. The resource grid is defined by multiple subcarriers and multiple OFDM symbols. The number of subcarriers constituting one slot depends on each of the downlink and uplink bandwidths of a cell. Each element in the resource grid is referred to as a resource element. The resource element may be identified by using a subcarrier number and an OFDM symbol number.

A resource block is used to represent mapping of a certain physical downlink channel (such as the PDSCH) or a certain physical uplink channel (such as the PUSCH) to resource elements. As the resource block, a virtual resource block and a physical resource block are defined. A certain physical uplink channel is first mapped to a virtual resource block. Thereafter, the virtual resource block is mapped to a physical resource block. In a case that the number X of OFDM symbols included in a slot is 7 and NCPs are used, one physical resource block is defined by 7 continuous OFDM symbols in the time domain and by 12 continuous subcarriers in the frequency domain. Hence, one physical resource block includes (7*12) resource elements. In a case of Extended CP (ECP), one physical resource block is defined by 6 continuous OFDM symbols in the time domain and by 12 continuous subcarriers in the frequency domain, for example. Hence, one physical resource block includes (6*12) resource elements. At this time, one physical resource block corresponds to one slot in the time domain and corresponds to 180 kHz in the frequency domain. Physical resource blocks are numbered from 0 in the frequency domain.

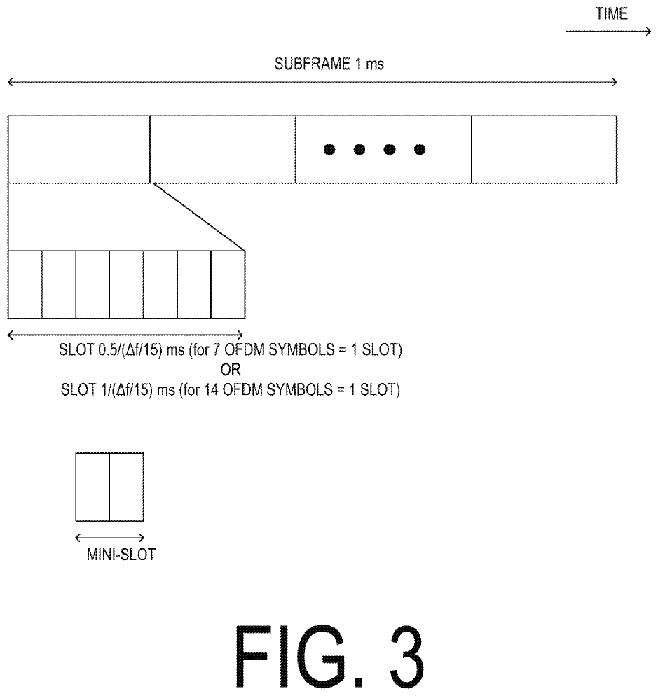

The subframe, the slot, and a mini-slot will now be described. FIG. 3 is a diagram illustrating the relationship between the subframe and the slot and the mini-slot in the time domain. As illustrated in FIG. 3, three types of time units are defined. The subframe is 1 ms regardless of the subcarrier spacing. The number of OFDM symbols included in the slot is 7 or 14, and the slot length depends on the subcarrier spacing. Here, in a case that the subcarrier spacing is 15 kHz, 14 OFDM symbols are included in one subframe. Thus, with the assumption that the subcarrier spacing is Δf (kHz), the slot length may be defined as 0.5/(Δf/15) ms in a case that the number of OFDM symbols constituting one slot is 7. Here, Δf may be defined by subcarrier spacing (kHz). In a case that the number of OFDM symbols constituting one slot is 7, the slot length may be defined as 1/(Δf/15) ms. Here, Δf may be defined by subcarrier spacing (kHz). Furthermore, the slot length may be defined as X/14/(Δf/15) ms, where X is the number of OFDM symbols included in the slot.

The mini-slot (which may be referred to as a sub-slot) is a time unit including OFDM symbols that are less in number than the OFDM symbols included in the slot. FIG. 3 illustrates, by way of example, a case that the mini-slot includes 2 OFDM symbols. The OFDM symbols in the mini-slot may match the timing for the OFDM symbols constituting the slot. Note that the smallest unit of scheduling may be a slot or a mini-slot.

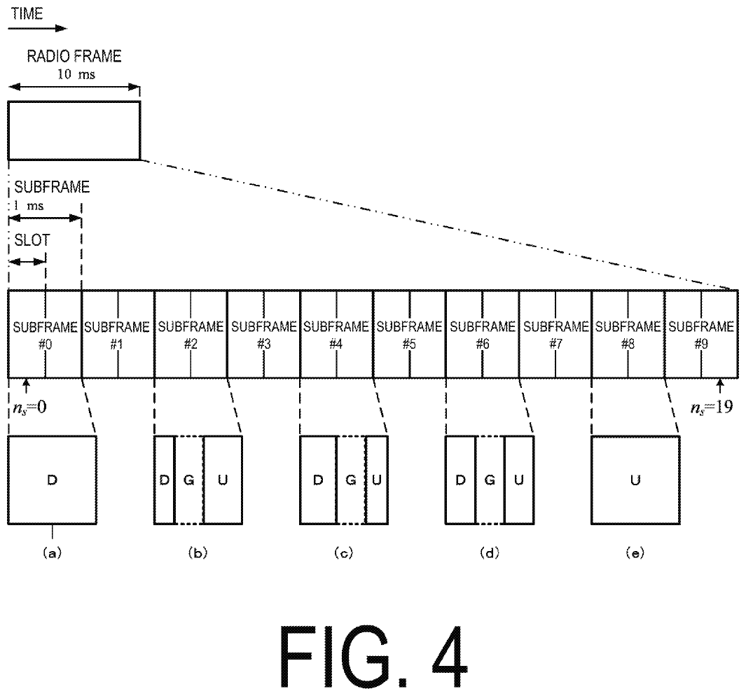

FIG. 4 is a diagram illustrating an example of a slot or a subframe. Here, a case in which the slot length is 0.5 ms at a subcarrier spacing of 15 kHz is illustrated as an example. In FIG. 4, D represents the downlink, and U represents the uplink. As illustrated in FIG. 4, during a certain time interval (for example, the minimum time interval to be allocated to one UE in the system), the subframe may include at least one of the followings:
downlink part (duration),
gap, or
uplink part (duration).

FIG. 4(a) is an example in which the entire subframe is used for downlink transmission during a certain time interval (which may be referred to as, for example, a minimum unit of a time resource that can be allocated to one UE, or a time unit, or multiple minimum units of time resources that are bundled may be referred to as a time unit). In FIG. 4(b), an uplink is scheduled via the NR-PDCCH for example by using the first time resource, and an uplink signal is transmitted after a gap for a processing delay of the NR-PDCCH, a time for switching from the downlink to the uplink, and generation of a transmit signal. In FIG. 4(c), the downlink NR-PDCCH and/or the downlink NR-PDSCH are transmitted by using the first time resource, and the NR-PUSCH or the NR-PUCCH are transmitted after a gap for a processing delay, a time for switching from the downlink to the uplink, and generation of a transmit signal. Here, by way of example, the uplink signal may be used to transmit the HARQ-ACK and/or the CSI, namely, the UCI. In FIG. 4(d), the NR-PDCCH and/or the NR-PDSCH are transmitted by using the first time resource, and the NR-PUSCH and/or the NR-PUCCH are transmitted after a gap for a processing delay, a time for switching from the downlink to the uplink, and generation of a transmit signal. Here, by way of example, the uplink signal may be used to transmit the uplink data, namely, the UL-SCH. FIG. 4(e) is an example in which the entire subframe is used for uplink transmission (NR-PUSCH or NR-PUCCH).

The above-described downlink part and uplink part may include multiple OFDM symbols as is the case with LTE.

Beamforming, beam management and/or beam sweeping according to the embodiment of the present invention will be now described.

Beamforming on the transmission side (which is the base station apparatus 3 in a case of the downlink, and is the terminal apparatus 1 in a case of the uplink) is a method of controlling, in an analogue or digital manner, the amplitude/phase of a signal for each of multiple transmit antenna elements to transmit the signal with a high transmit antenna gain in a selected direction, and a field pattern thereof is referred to as transmission beam. Beamforming on the reception side (which is the terminal apparatus 1 in the case of the downlink, and is the base station apparatus 3 in the case of the uplink) is a method of controlling, in an analogue or digital manner, the amplitude/phase of a signal for each of multiple receive antenna elements to receive the signal with a high receive antenna gain in a selected direction, and a field pattern thereof is referred to as reception beam. Beam management may be an operation of the base station apparatus 3 and/or the terminal apparatus 1 for directivity alignment of the transmission beam and/or the reception beam, and/or for acquiring beam gain.

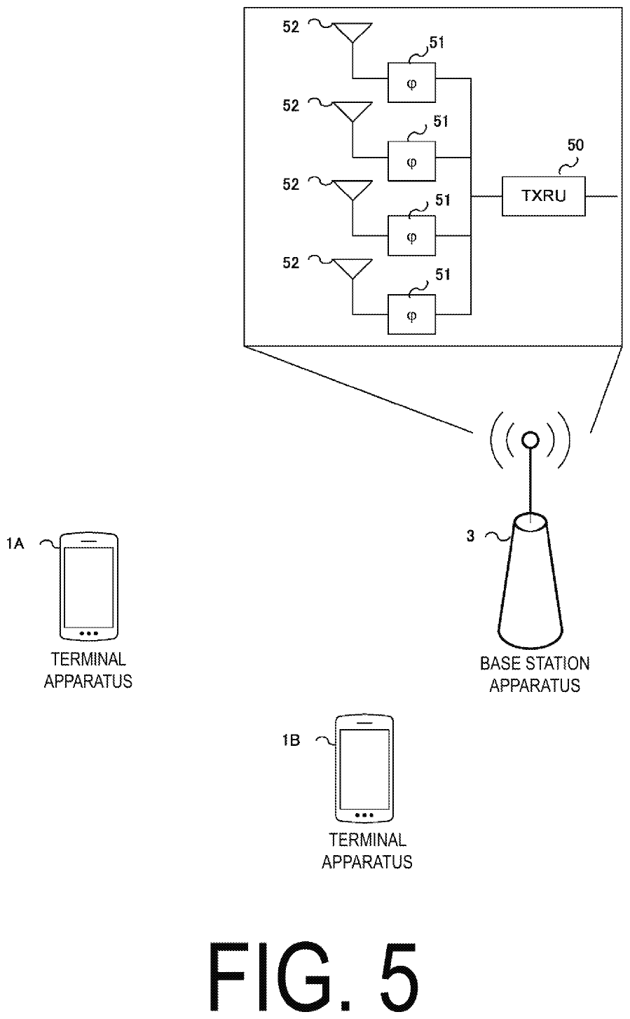

FIG. 5 illustrates an example of beamforming. Multiple antenna elements are connected to one Transceiver unit (TXRU) 50. The phase is controlled by using a phase shifter 51 for each antenna element and a transmission is performed from an antenna element 52, thus allowing a beam for a transmit signal to be directed in any direction. Typically, the TXRU 50 may be defined as an antenna port, and only the antenna port may be defined for the terminal apparatus 1. Controlling the phase shifter 51 allows setting of directivity in any direction. Thus, the base station apparatus 3 can communicate with the terminal apparatus 1 by using a high gain beam.

The beamforming may be referred to as virtualization, precoding, and multiplication with a weight, for example. The signal itself transmitted by using beamforming simply may be referred to as a transmission beam.

In the present embodiment, in the beamforming of uplink transmission, a transmission beam used by the terminal apparatus 1 is also referred to as uplink transmission beam (UL Tx beam), and in the beamforming of uplink reception, a reception beam used by the base station apparatus 3 is also referred to as uplink reception beam (UL Rx beam). However, the uplink transmission beam may be referred to as a transmission spatial filter configuration in the terminal apparatus 1, and the uplink reception beam may be referred to as a reception spatial filter configuration in the base station apparatus 3. In the beamforming of downlink transmission, a transmission beam used by the base station apparatus 3 is also referred to as downlink transmission beam (DL Tx beam), and in the beamforming of downlink reception, a reception beam used by the terminal apparatus 1 is also referred to as downlink reception beam (DL Rx beam). However, the downlink transmission beam may be referred to as a transmission spatial filter configuration in the base station apparatus 3, and the downlink reception beam may be referred to as a reception spatial filter configuration in the terminal apparatus 1. Note that the uplink transmission beam and the uplink reception beam may be collectively referred to as an uplink beam, and the downlink transmission beam and the downlink reception beam may be collectively referred to as a downlink beam. Note that processing performed by the terminal apparatus 1 for the uplink beamforming may be referred to as uplink transmission beam processing or uplink precoding, and processing performed by the base station apparatus 3 for the uplink beamforming may be referred to as uplink reception beam processing. Note that processing performed by the terminal apparatus 1 for the downlink beamforming may be referred. to as downlink reception beam processing, and processing performed by the base station apparatus 3 for the downlink beamforming may be referred to as downlink transmission beam processing or downlink precoding.

However, the base station apparatus 3 may transmit a signal by using multiple downlink transmission beams at one OHM symbol. For example, the antenna element of the base station apparatus 3 may be divided into subarrays to perform downlink beamforming differently for each of the subarrays. Downlink beamforming may be performed differently for each polarization by using a polarization antenna. Similarly, the terminal apparatus 1 may transmit a signal by using multiple uplink transmission beams at one OFDM symbol.

However, although, in the present embodiment, a case is described in which the base station apparatus 3 switches and uses multiple downlink transmission beams in a cell configured by the base station apparatus 3 and/or the transmission reception point 4, individual cells may be configured for each downlink transmission beam.

The beam management according to the present embodiment may include the following operations.
Beam selection
Beam refinement
Beam recovery

For example, the beam selection may be an operation for selecting a beam in the communication between the base station apparatus 3 and the terminal apparatus 1. The beam refinement may be an operation for selecting a beam having a higher gain or changing a beam to an optimum beam between the base station apparatus 3 and the terminal apparatus 1 according to the movement of the terminal apparatus 1. The beam recovery (which may also be referred to as Beam Failure Recovery) may be an operation for re-selecting the beam in a case that the quality of a communication link is degraded due to blockage caused by a blocking object, a passing human being, or the like in the communication between the base station apparatus 3 and the terminal apparatus 1. The above operations are not limited to the above purposes. The base station apparatus 3 may perform beam management in a variety of situations and, therefore, can exert an effect without limiting the purpose.

For example, a reference signal (for example, CSI-RS) or Quasi Co-Location QCL) assumption may be used for the terminal apparatus 1 to select the transmission beam for the base station apparatus 3.

In a case that a Long Term Property of a channel on which one symbol in one antenna port is carried may be estimated from a channel on which one symbol in the other antenna port is carried, the two antenna ports are said to be QCL. The long term property of the channel includes at least one of a delay spread, a Doppler spread, a Doppler shift, an average gain, or an average delay. For example, in a case that an antenna port 1 and an antenna port 2 are QCL with respect to the average delay, this means that a reception timing for the antenna port 2 may be estimated from a reception timing for the antenna port 1.

The QCL may also be expanded to beam management. For this purpose, spatially expanded QCL may be newly defined. For example, one or multiple of the followings may be further included in addition to the above as the Long term properties of the channel in the spatial QCL assumption.
Angle of Arrival ((AoA), a Zenith angle of Arrival (ZoA), or the like) and/or its Angle Spread (for example, Angle Spread of Arrival (ASA) or a Zenith angle Spread of Arrival (ZSA)) in a radio link or channel
Angle of departure (AoD, ZoD, or the like) and/or an Angle Spread of the transmission angle (for example, an Angle Spread of Departure (ASD) or a Zenith angle Spread of Departure (ZSS)) in a radio link or channel
Spatial Correlation

According to this method, operations of the base station apparatus 3 and the terminal apparatus 1 equivalent to beam management may be defined as beam management, based on the spatial QCL assumption and radio resources (time and/or frequency).

Note that an antenna port may be allocated to each of the precoding or each of the transmission beams. For example, a signal to be transmitted by using a different precoding or a signal to be transmitted by using a different transmission beam according to the present embodiment may be defined as a signal to be transmitted through a different antenna port or multiple different antenna ports. However, the antenna port is defined as an antenna port that allows a channel on which a certain symbol is transmitted through a certain antenna port, to be inferred from a channel on which another symbol is transmitted through the same antenna port. The same antenna port also means that the antenna port number (the number for identifying an antenna port) may be the same. An antenna port set may include multiple antenna ports. The same antenna port set also means that the antenna port set number (the number for identifying an antenna port set) may be the same. A signal to be transmitted by applying a different uplink transmission beam also means that the signal may be transmitted through a different antenna port or a different antenna port set including multiple antenna ports. A beam index may be an OFDM symbol number, an antenna port number, or an antenna port set number.

A complex modulation symbol for one or multiple layers generated by layer mapping is input into transform precoding. The transform precoding may be processing for dividing a block of complex-valued symbols into sets for each layer corresponding to one OFDM symbol. In a case that the OFDM is used, Discrete Fourier Transform (DFT) processing in the transform precoding may not be necessary.

In the precoding, the block of vectors obtained from a transform precoder may be input to generate a block of vectors to be mapped to a resource element. In a case of spatial multiplexing, one of precoding matrices may be adapted in generating the block of vectors to be mapped to a resource element. This processing may be referred to as digital beamforming. The precoding may be defined to include analog beamforming and digital beamforming, or may be defined as digital beamforming. The beamforming may be applied to a precoded signal, and the precoding may be applied to a signal to which the beamforming is applied.

The beamforming may include digital beamforming and may not include analog beamforming, or may include both digital beamforming and analog beamforming. A beamformed signal, a precoded signal, or a beamformed and precoded signal may be referred to as a beam. A beam index may be a precoding matrix index. The beam index and the precoding matrix index may be defined independently. The precoding matrix indicated by the precoding matrix index may be applied to the beam indicated by the beam index to generate a signal. The beamforming indicated by the beam index may be applied to the signal to which the precoding matrix indicated by the precoding matrix index is applied, to generate a signal. The digital beamforming may include application of a different precoding matrix to a resource in a frequency direction (for example, a set of subcarriers).

However, in this embodiment, a radio link configured by using a prescribed transmission beam and/or a prescribed reception beam may be referred to as a beam pair link. For example, in the downlink, beam pair links configured by using different downlink transmission beams and/or different downlink reception beams may be referred to as different downlink beam pair links. For example, in the uplink, beam pair links configured by using different uplink transmission beams and/or different uplink reception beams may be referred to as different uplink beam pair links. For example, a state in which the terminal apparatus 1 may receive downlink signals by using multiple downlink transmission beams and/or multiple downlink reception beams in a certain cell may be referred to as a state having multiple downlink beam pair links. For example, a state in which the terminal apparatus 1 may transmit uplink signals by using multiple uplink transmission beams and/or multiple uplink reception beams in a certain cell may be referred to as a state having multiple uplink beam pair links. A downlink beam pair link may be referred to as one or multiple downlink physical signals or one or multiple downlink physical channels associated with one or multiple downlink reference signals, based on information received from the base station apparatus. This association may be performed by a QCL configuration. The QCL configuration may include information for configuring the association of one or multiple downlink reference signals and one or multiple PDSCH DMRS ports identified by the transmission configuration identification (TCI). The QCL configuration may include information for associating the TCI and the COntrol REsource SET (CORESET). The control resource set is a set of resources for the PDCCH. The terminal apparatus 1 may associate a downlink reception beam with the downlink beam pair link. The uplink beam pair link may be referred to as one or multiple uplink physical signals or one or multiple uplink physical channels associated with one or multiple uplink reference signals (SRS or the like), based on information received from the base station apparatus. The base station apparatus 3 may associate an uplink reception beam with the uplink beam pair link.

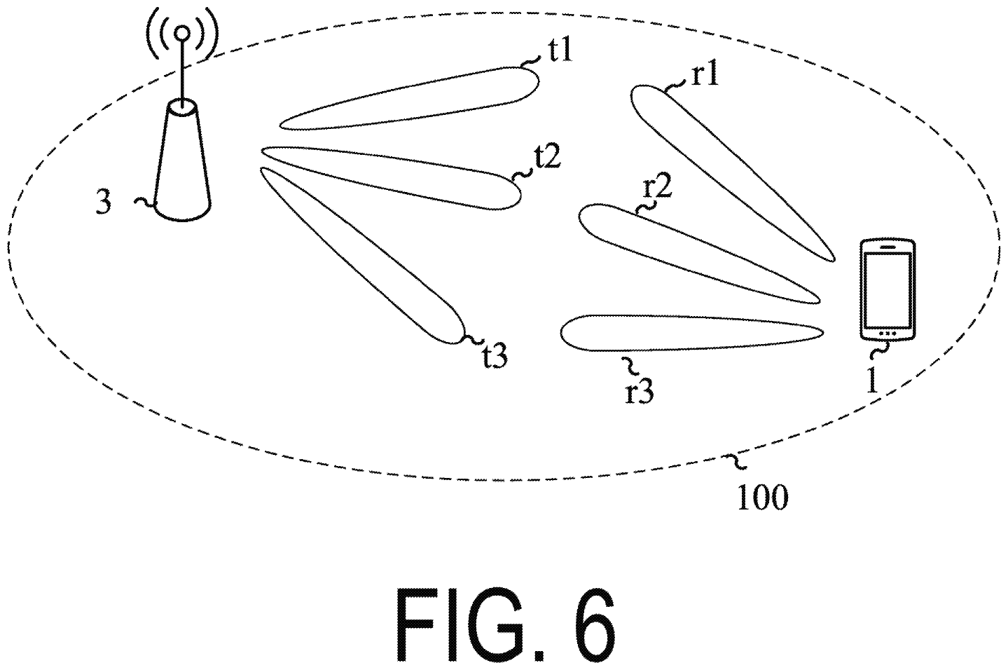

FIG. 6 illustrates a case that the terminal apparatus 1 and the base station apparatus 3 configure multiple downlink beam pair links in the cell 100. As the first downlink beam pair link, the terminal apparatus 1 receives, by using the downlink reception beam r1, the downlink signal transmitted from the base station apparatus 3 by using the downlink transmission beam t1. As the second downlink beam pair link, the terminal apparatus 1 receives, by using the downlink reception beam r2, the downlink signal transmitted from the base station apparatus 3 by using the downlink transmission beam t2. As the third downlink beam pair link, the terminal apparatus 1 receives, by using the downlink reception beam r3, the downlink signal transmitted from the base station apparatus 3 by using the downlink transmission beam t3. In this case, three downlink beam pair links are configured between the terminal apparatus 1 and the base station apparatus 3, and downlink transmission and/or reception is performed in all or some of the three downlink beam pair links. For example, the terminal apparatus 1 performs measurement of the received power and/or reception quality by a reference signal in each downlink beam pair link.

Note that, multiple downlink beam pair links may be configured for one downlink transmission beam by using multiple downlink reception beams. Note that, multiple downlink beam pair links may be configured for one downlink reception beam by using multiple downlink transmission beams. Note that, regardless of the downlink reception beam to be used, one downlink beam pair link may be associated with one downlink transmission beam. Note that, regardless of the uplink transmission beam to be used, one uplink beam pair link may be associated with one uplink reception beam.

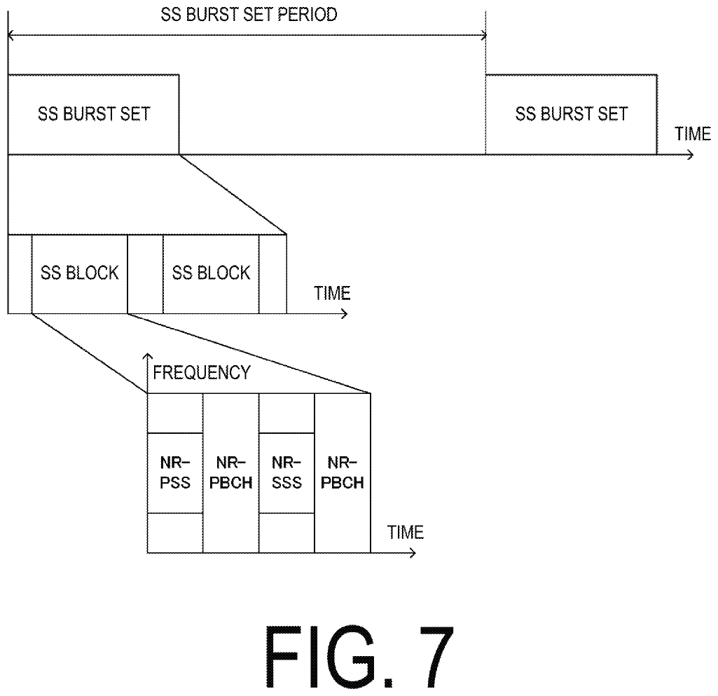

FIG. 7 is a diagram illustrating an example of Synchronization Signal (SS) blocks (also referred to as synchronization signal/physical broadcast channel blocks (SS/PBCH blocks)) and SS burst sets (also referred to as synchronization signal burst sets) according to the present embodiment. FIG. 7 illustrates an example in which two SS blocks are included in the SS burst set transmitted periodically, and the SS block includes 4 OFDM symbols.

The SS block is a unit block including synchronization signals (for example, the NR-PSS, the NR-SSS), and/or the NR-PBCH. In a case that the base station apparatus 3 transmits the synchronization signal and/or the NR-PBCH by using one or multiple SS blocks in the SS burst set, a downlink transmission beam independent for each SS block may be used.

FIG. 7 illustrates an example in which the NR-PSS, the NR-SSS, and the NR-PBCH are time-multiplexed in one SS block, and the NR-PBCH transmitted with a bandwidth greater than the bandwidth of the NR-PSS and/or NR-SSS is multiplexed for two symbols. However, the order in which the NR-PSS, the NR-SSS, and/or the NR-PBCH are multiplexed in the time domain may be different from the example illustrated in FIG. 7. For example, in a case that the NR-PBCH is transmitted in two symbols, an OFDM symbol for transmitting the NR-SSS may be present between the two NR-PBCH symbols. However, a portion of the NR-PBCH may be frequency-multiplexed to the same symbol as the NR-SSS.

The SS burst set may be transmitted periodically. For example, a period used for initial access and a period configured for a connected (Connected or RRC_Connected) terminal apparatus may be defined. The period configured for the connected (Connected or RRC_Connected) terminal apparatus may be configured in the RRC layer. The period configured for the connected (Connected or RRC_Connected) terminal may be a period of a radio resource in the time domain during which transmission is potentially to be performed, and in practice, whether the transmission is to be performed during the period may be determined by the base station apparatus 3. The period used for the initial access may be predefined in specifications or the like.

The SS burst set may be determined based on a System Frame Number (SFN). A starting position of the SS burst set (boundary) may be determined based on the SFN and the period.

An index (also referred to as an SS block index) is allocated to the SS block according to the temporal position in the SS burst set. The terminal apparatus 1 calculates the index, based on the information of the NR-PBCH included in the detected. SS block and/or the information of the reference signal.

SS blocks with the same relative time in each SS burst set in multiple SS burst sets are allocated the same SS block index. The same downlink transmission beam may be assumed to be applied to SS blocks having the same relative time within each SS burst set in the multiple SS burst sets. Antenna ports for SS blocks having the same relative time within each SS burst set in the multiple SS burst sets may be assumed to be QCL with respect to the average delay, the Doppler shift, and the spatial correlation.

SS blocks allocated the same index within a period of a certain SS burst set may be assumed to be QCL with respect to an average delay, an average gain, a Doppler spread, a Doppler shift, and a spatial correlation. A configuration corresponding to one or multiple SS blocks (or may be reference signals) which are QCL may be referred to as a QCL configuration.

The number of SS blocks may be defined as, for example, the number of SS blocks in an SS burst or an SS burst. set, or in a period of SS blocks. The number of SS blocks may indicate the number of beam groups for cell selection in an SS burst or in an SS burst set, or in a period of SS blocks. Here, a beam group may be defined as the number of SS blocks or different beams included in an SS burst or in an SS burst set, or in a period of SS blocks.

Hereinafter, the reference signal described in the present embodiment includes a downlink reference signal, a synchronization signal, an SS block, a downlink DM-RS, a CSI-RS, an uplink reference signal, an SRS, and/or an uplink DM-RS. For example, the downlink reference signal, the synchronization signal, and/or the SS block may be referred to as a reference signal. The reference signal used in the downlink includes a downlink reference signal, a synchronization signal, an SS block, a downlink DM-RS, a CSI-RS, and the like. The reference signal used in the uplink includes an uplink reference signal, an SRS, and/or an uplink DM-RS, and the like.

Notification of the SRS resource according to the present embodiment will be described.

The base station apparatus 3 notifies the terminal apparatus 1 of one or multiple of the resources in which the SRS is transmitted, by transmitting an SRS Resource Indicator (SRI). The one or multiple SRS resources are associated with at least one antenna port and/or one uplink transmission beam (which may be a transmission spatial filter configuration or a precoder of the terminal apparatus 1). The terminal apparatus 1 receiving the SRI information may determine the antenna port and/or the uplink transmission beam to be used for the uplink transmission, based on the SRI.

A Random Access procedure according to the present embodiment will be described.

The random access procedure is classified into two procedures: Contention Based (CB) and non-Contention Based (non-CB) (which may be referred to as Contention Free (CF)). The contention based random access is also referred to as CBRA, and the non-contention based random access is also referred to as CFRA.

The random access procedure is initiated by a PDCCH order, a MAC entity, a beam failure notification from a lower layer, or RRC or the like.

The contention based random access procedure is initiated by a PDCCH order, a MAC entity, a beam failure notification from a lower layer, or RRC or the like. In a case that the beam failure notification is provided by the physical layer of the terminal apparatus 1 to the MAC entity of the terminal apparatus 1, and that a certain condition is satisfied, the MAC entity of the terminal apparatus 1 initiates the random access procedure. The procedure for determining whether or not a certain condition has been satisfied and initiating a random access procedure in a case that the beam failure notification is provided from the physical layer of the terminal apparatus 1 to the MAC entity of the terminal apparatus 1 may be referred to as a beam failure recovery procedure. This random access procedure is a random access procedure for a beam failure recovery request. The random access procedure initiated by the MAC entity includes a random access procedure initiated by a scheduling request procedure. The random access procedure for the beam failure recovery request may or may not be considered as a random access procedure initiated by the MAC entity. The random access procedure for the beam failure recovery request and the random access procedure initiated by the scheduling request procedure may perform different procedures, so the random access procedure for the beam failure recovery request and the scheduling request procedure may be differentiated. The random access procedure for the beam failure recovery request and the scheduling request procedure may be a random access procedure initiated by the MAC entity. In an embodiment, the random access procedure initiated by the scheduling request procedure may be referred to as a random access procedure initiated by the MAC entity, and the random access procedure for the beam failure recovery request may be referred to as a random access procedure, based on a notification of beam failure from a lower layer. Hereinafter, an initiation of a random access procedure in a case of receiving a notification of a beam failure from a lower layer may refer to an initiation of a random access procedure for the beam failure recovery request.

The terminal apparatus 1 performs a contention based random access procedure at the time of initial access from a state in which the terminal apparatus 1 is not connected (not in communication) with the base station apparatus 3, and/or at a time of scheduling request in a case that uplink data that can be transmitted or sidelink data that can be transmitted to the terminal apparatus 1 occurs while being connected to the base station apparatus 3, and/or the like. However, the use of contention based random access is not limited thereto.

The occurrence of the uplink data that can be transmitted to the terminal apparatus 1 may include that a buffer status report is triggered, the buffer status report corresponding to the uplink data that can be transmitted. The occurrence of the uplink data that can be transmitted to the terminal apparatus 1 may include pending of the scheduling request triggered based on the occurrence of the uplink data that can be transmitted.

The occurrence of the sidelink data that can be transmitted to the terminal apparatus 1 may include a buffer status report is triggered, the buffer status report corresponding to the sidelink data that can be transmitted. The occurrence of the sidelink data that can be transmitted to the terminal apparatus 1 may include pending of the scheduling request triggered based on the occurrence of the sidelink data that can be transmitted.

The non-contention based random access procedure may be initiated in a case that the terminal apparatus 1 receives information for indicating an initiation of a random access procedure from the base station apparatus 3. The non-contention based random access procedure may be initiated in a case that the MAC layer of the terminal apparatus 1 receives the notification of the beam failure from a lower layer.

The non-contention based random access may be used to quickly perform uplink synchronization between the terminal apparatus 1 and the base station apparatus 3 in a case that the base station apparatus 3 and the terminal apparatus 1 are in connection but the handover or the transmission timing of the mobile station apparatus is not enabled. The non-contention based random access may be used to transmit a beam failure recovery request in a case that a beam failure occurs in the terminal apparatus 1. However, the use of non-contention based random access is not limited thereto.

Note that, information for indicating the initiation of the random access procedure may be referred to as message 0, Msg. 0, an NR-PDCCH order, a PDCCH order, or the like.

Note that, in a case that the random access preamble index indicated by message 0 is a prescribed value (for example, in a case that all of the bits for indicating the index are 0), the terminal apparatus 1 may perform a contention based random access procedure for randomly selecting and transmitting one from among a set of preambles available for the terminal apparatus 1.

The terminal apparatus 1 according to the present embodiment receives the random access configuration information via a higher layer prior to initiating the random access procedure. The random access configuration information may include information described below or information to determine/configure the information described below.
Set of one or multiple time/frequency resources available for transmission of the random access preamble
One or multiple random access preamble groups
One or multiple available random access preambles or one or multiple random access preambles available in the multiple random access preamble groups
Random access response window size and Contention Resolution timer (mac-ContentionResolutionTimer)
Power ramping step
Maximum number of transmissions of preamble transmission
Initial transmit power of the preamble
Power offset based on preamble format
Maximum number of power ramping
Threshold value of reference signal received power (RSRP)

However, the random access configuration information may include common information in the cell, and may include dedicated information different for each terminal.

Note that, a portion of the random access configuration information may be associated with all the SS blocks in the SS burst set. Note that, a portion of the random access configuration information may be associated with all of the one or multiple CSI-RSs configured. Note that, a portion of the random access configuration information may be associated with one downlink transmission beam (or beam index).

Note that, a portion of the random access configuration information may be associated with one SS block in the SS burst set. Note that, a portion of the random access configuration information may be associated with one of the one or multiple CSI-RSs configured. Note that, a portion of the random access configuration information may be associated with one downlink transmission beam (or beam index). Note that, information associated with one SS block, one CSI-RS, and/or one downlink transmission beam may include index information for identifying one corresponding SS block, one CSI-RS, and/or one downlink transmission beam (for example, an SS block index, a beam index, or a QCL configuration index).

Note that, the random access configuration information may be configured for each SS block in the SS burst set, or one piece of random access configuration information common to all the SS blocks in the SS burst set may be configured. The terminal apparatus 1 may receive one or multiple pieces of random access configuration information by a downlink signal, and each of the one or multiple pieces of random access configuration information may be associated with an SS block (which may be a CSI-RS or a downlink transmission beam). The terminal apparatus 1 may select one of the received one or multiple SS blocks (which may be CSI-RSs or downlink transmission beams), and perform a random access procedure by using the random access configuration information associated with the selected SS blocks.

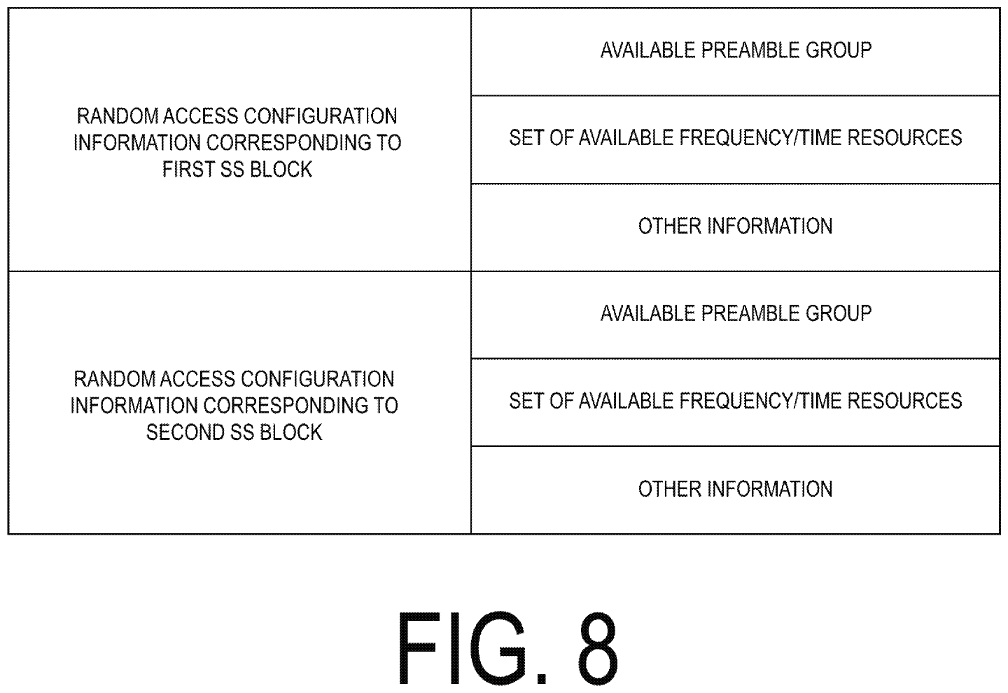

FIG. 8 is a diagram illustrating an example of a configuration of the random access configuration information according to the present embodiment. In FIG. 8, the terminal apparatus 1 receives the random access configuration information corresponding to the first SS block and the random access configuration information corresponding to the second SS block. Each of the random access configuration information corresponding to the first SS block and the random access configuration information corresponding to the second SS block include a preamble group available for random access, a set of time/frequency resources, and other information (for example, SS block index may be included).

However, in FIG. 8, a case is illustrated in which the terminal apparatus 1 receives two pieces of random access configuration information corresponding to two SS blocks, but the terminal apparatus 1 may receive three or more pieces of random access configuration information corresponding to three or more SS blocks.

However, in the example illustrated in FIG. 8, a case is illustrated in which each of the information included in the random access configuration information is present for each SS block, but some of the information included in the random access configuration information may be configured in common in multiple SS blocks. For example, some of the random access configuration information may be information configured for each SS block, CSI-RS, or downlink transmission beam (transmission filter configuration of the base station apparatus 3), and the other information may be information configured for each cell.

One or multiple time/frequency resources available for transmission of the random access preamble is hereinafter referred to as a random access channel (RACH) occasion. However, a set of physical random access channel occasions (PRACH occasions) or random access channel transmission occasions (which may be referred to as RACH transmission occasions) may be configured for each reference signal (for example, an SS block, a CSI-RS, or a downlink transmission beam). For example, each of the one or multiple RACH occasions available for transmission of the random access preamble included in the random access configuration information may be a time/frequency resource for one random access preamble transmitted by using the configured preamble format. For example, each of the one or multiple RACH occasions available for transmission of the random access preamble included in the random access configuration information may be a time/frequency resource for one random access preamble transmitted by using the configured preamble format by using one uplink transmission beam. The RACH occasion may mean one or multiple time resources available for transmission of the random access preamble. In this case, because the identification of the RACH occasion is only for a time resource, identification of a frequency resource used for transmission of the random access preamble is further performed. The terminal apparatus 1 may select a set of one or multiple RACH occasions available for transmission of the random access preamble, based on the received reference signal (for example, SS block, CSI-RS, or downlink transmission beam). Note that, the RACH occasion may be associated with a configuration index notified with the random access configuration information. Note that, a set of one or multiple RACH occasions may be referred to as a random access resource or a random access channel resource (RACH resource).

Each of one or multiple random access preamble groups included in the random access configuration information may be associated with each reference signal (for example, the SS block, the CSI-RS, or the downlink transmission beam). The terminal apparatus 1 may select a random access preamble group, based on the received reference signal (for example, the SS block, the CSI-RS, or the downlink transmission beam).

However, the random access preamble group associated with each SS block may be identified by one or multiple parameters notified by the higher layer. One of the one or multiple parameters may be one index (for example, a start index) of the available one or multiple preambles. One of the one or multiple parameters may be the number of preambles available for contention based random access per SS block. One of the one or multiple parameters may be the sum of the number of preambles available for contention based random access per SS block and the number of preambles available for non-contention based random access. One of the one or multiple parameters may be the number of SS blocks associated with one RACH occasion.

Note that, in the example of FIG. 8, a case is illustrated in which one piece of random access configuration information is associated with one SS block, but the one piece of random access configuration information may be associated with one index (for example, SS block index, CSI-RS index, downlink transmission beam index, or the like).

Note that, the terminal apparatus 1 may receive one or multiple downlink signals transmitted by using one downlink transmission beam for each, receive the random access configuration information associated with one downlink signal therein, and perform a random access procedure, based on the received random access configuration information. The terminal apparatus 1 may receive one or multiple SS blocks in the SS burst set, receive random access configuration information associated with one SS block therein, and perforin a random access procedure, based on the received random access configuration information. The terminal apparatus 1 may receive one or multiple CSI-RSs, receive random access configuration information associated with one CSI-RS therein, and perform a random access procedure, based on the received random access configuration information.

One or multiple pieces of random access configuration information may be configured by one random access channel configuration (RACH-Config) and/or one physical random access channel configuration (PRACH-Config).

A parameter related to random access for each reference signal may be included in the random access channel configuration.

A parameter related to a physical random access channel for each reference signal (index of PRACH configuration, RACH occasion, or the like) may be included in the physical random access channel configuration.

One piece of random access configuration information may indicate a parameter related to random access corresponding to one reference signal, and multiple pieces of random access configuration information may indicate parameters related to multiple random access corresponding to multiple reference signals.

One piece of random access configuration information may indicate a parameter related to physical random access corresponding to one reference signal, and may indicate parameters related to multiple random access corresponding to multiple reference signals.

In a case that a corresponding reference signal is selected, the random access configuration information corresponding to the reference signal (the random access channel configuration corresponding to the reference signal, the physical random access channel configuration corresponding to the reference signal) may be selected.

However, the terminal apparatus 1 may receive one or multiple pieces of random access configuration information from a base station apparatus 3 and/or a transmission reception point 4 different from a base station apparatus 3 and/or a transmission reception point 4 transmitting the random access preamble. For example, the terminal apparatus 1 may transmit the random access preamble to a second base station apparatus 3, based on at least one of the random access configuration information received from a first base station apparatus 3.

However, the base station apparatus 3 may determine the downlink transmission beam to be applied in transmitting the downlink signal to the terminal apparatus 1, by receiving the random access preamble transmitted by the terminal apparatus 1. The terminal apparatus 1 may transmit the random access preamble by using the RACH occasion indicated in the random access configuration information associated with a certain downlink transmission beam. The base station apparatus 3 may determine the downlink transmission beam to be applied in transmitting the downlink signal to the terminal apparatus 1, based on the random access preamble received from the terminal apparatus 1 and/or the RACH occasion in which the random access preamble is received.

The base station apparatus 3 transmits, to the terminal apparatus 1, an RRC parameter including one or multiple pieces of random access configuration information (which may include a random access resource) as an RRC message. An example of an RRC parameter configuration of the random access configuration information according to the present embodiment will be described below.

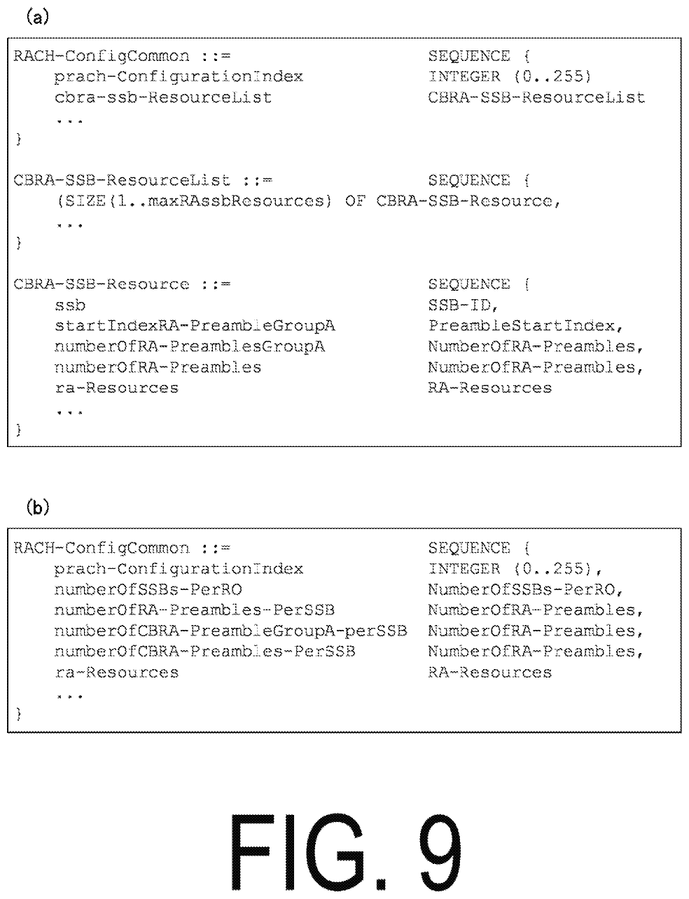

FIG. 9 is a diagram illustrating an example of an RRC parameter configuration of random access configuration information according to the present embodiment. In FIG. 9(a), RACH-ConfigCommon is a parameter including a random access configuration common in cells, and includes the RRC parameter prach-ConfigurationIndex and/or cbra-ssb-ResourceList. prach-ConfigurationIndex is information (RRC parameter) for indicating an index of 0 to 255 corresponding to prach-config to be applied among prach-config for indicating a combination of L1 parameters determined by using a table in the specification. The parameters defined in prach-ConfigurationIndex may include a preamble format, a configuration period, a subframe number, a start symbol index in a subframe or a slot, the number of random access slots (also referred to as RACH slots) included in the subframe, and/or the number of RACH occasions in the RACH slot. Because the parameters defined in prach-ConfigurationIndex also include RACH occasions, the following ra-Resources may vary in interpretation depending on the parameters defined in prach-ConfigurationIndex. The resources within the RACH occasion defined by prach-ConfigurationIndex may be specified by ra-Resources. cbra-ssb-ResourceList is information (RRC parameter) for indicating a list of parameters CBRA-SSB-Resource for indicating a contention based random access resource corresponding to each of one or multiple SS blocks transmitted by the base station apparatus 3.

CBRA-SSB-Resource includes RRC parameters ssb, startIndexRA-PreambleGroupA, numberOfRA-PreamblesGroupA, numberOfRA-Preambles, and/or ra-Resources. ssb indicates the index (SSB-ID) of the SS block to which the parameters included in CBRA-SSB-Resource correspond. startIndexRA-PreambleGroupA indicates a start index (PreambleStartIndex) of a random access preamble group associated with a corresponding SSB-ID. numberOfRA-PreambleGroupA indicates the number of preambles (NumberOfRA-Preambles) corresponding to the group A of the contention based random access preambles associated with the corresponding SSB-ID. numberOfRA-Preambles indicates the total number of the contention based random access preambles associated with the corresponding SSB-ID. ra-Resources indicates a time/frequency resource (which may be a random access occasion) used for transmission of a contention based random access preamble associated with a corresponding SSB-ID.

FIG. 9(b) is a diagram illustrating another example of RACH-ConfigCommon according to the present embodiment. In FIG. 9(b), RACH-ConfigCommon includes RRC parameters prach-ConfigurationIndex, numberOfSSBs-PerRO, numberOfRA-Preambles-PerSSB, numberOfCBRA-PreamblesGroupA-PerSSB, numberOfCBRA-Preambles-PerSSB, and/or ra-Resources. numberOfSSBs-PerRO indicates the number of SS blocks associated with the same random access occasion. numberOfRA-Preambles-PerSSB indicates the total number of contention based random access preambles and non-contention based random access preambles associated with one SS block. numberOfCBRA-PreamblesGroupA-PerSSB indicates the number of preambles corresponding to the group A of the contention based random access preambles associated with one SS block. numberOfCBRA-Preambles-PerSSB indicates the number of preambles corresponding to the group A of the contention based random access preambles associated with one SS block.

The terminal apparatus 1 can identify a set of available random access preambles associated with each SS block and/or a time/frequency resource for transmitting the random access preambles, based on the RACH-ConfigCommon information illustrated in FIG. 9(a) or FIG. 9(b).

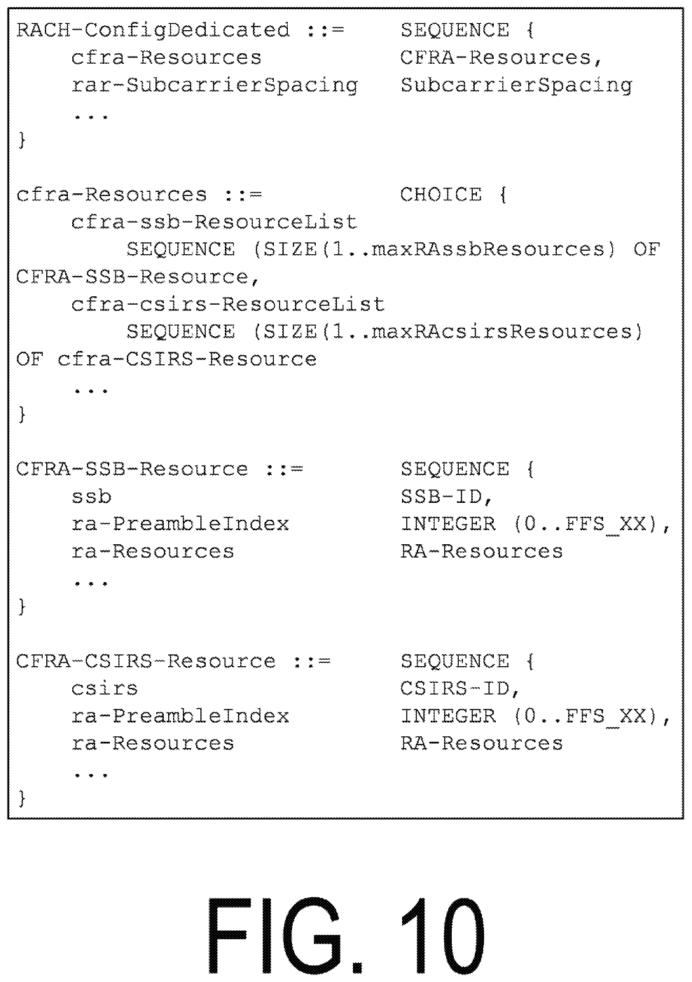

FIG. 10 is a diagram illustrating an example of a configuration of an RRC parameter RACH-ConfigDedicated according to the present embodiment. RACH-ConfigDedicated is a random access configuration configured for each terminal apparatus 1, and is used in a non-contention based random access procedure mainly in a case of synchronization reconfiguration, or the like (in a case of handover or the like). In FIG. 10, RACH-ConfigDedicated includes cfra-Resources and/or rar-SubcarrierSpacing. cfra-Resources is information for indicating a resource configuration for performing a non-contention based random access procedure. rar-SubcarrierSpacing is information for indicating a subcarrier spacing used in the random access response (message 2).

cfra-Resources includes RRC parameters cfra-ssb-ResourceList and/or cfra-csirs-ResourceList. cfra-ssb-ResourceList is information (RRC parameter) for indicating a list of parameters CFRA-SSB-Resource for indicating a non-contention based random access resource corresponding to each of one or multiple SS blocks transmitted by the base station apparatus 3. cfra-csirs-ResourceList is information (RRC parameter) for indicating a list of parameters CFRA-CSIRS-Resource for indicating a non-contention based random access resource corresponding to each of the one or multiple CSI-RSs transmitted by the base station apparatus 3.

CFRA-SSB-Resource includes RRC parameters ssb, ra-PreambleIndex, and/or ra-Resources. ssb indicates the index (SSB-ID) of the SS block to which the parameters included in CFRA-SSB-Resource correspond. ra-PreambleIndex indicates an index of a non-contention based random access preamble associated with a corresponding SSB-ID. ra-Resources indicates a time/frequency resource (which may be a random access occasion) used for transmission of a non-contention based random access preamble associated with a corresponding SSB-ID.

CFRA-CSIRS-Resource includes RRC parameters csirs, ra-PreambleIndex, and/or ra-Resources. csirs indicates an index (CSIRS-ID) of the CSI-RS to which the parameter included in CFRA-CSIRS-Resource corresponds. ra-PreambleIndex indicates an index of a non-contention based random access preamble associated with a corresponding CSIRS-ID. ra-Resources indicates a time/frequency resource (which may be a random access occasion) used for transmission of a non-contention based random access preamble associated with a corresponding CSIRS-ID.

In a case that the terminal apparatus 1 performs non-contention based random access on a handover or the like, the terminal apparatus 1 can identify the time/frequency resource for transmitting the index of the non-contention based random access preamble and/or the random access preamble associated with each SS block or CSI-RS, based on the information in RACH-ConfigDedicated illustrated in FIG. 10.

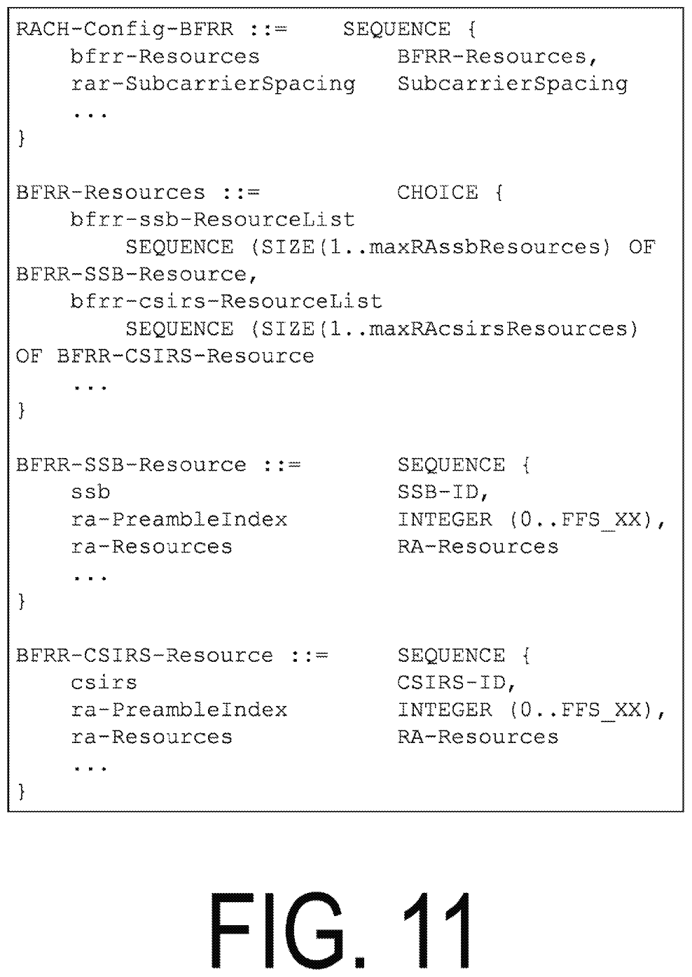

FIG. 11 is a diagram illustrating an example of a configuration of an RRC parameter RACH-Config-BFRR according to the present embodiment. RACH-Config-BFRR is a random access configuration configured for each terminal apparatus 1, and is used for a non-contention based random access procedure in a case of a beam failure recovery request. In FIG. 11, RACH-Config-BFRR includes bfrr-Resources and/or rar-SubcarrierSpacing. bfrr-Resources is information for indicating a resource configuration for performing a non-contention based random access procedure in a beam failure recovery request. rar-SubcarrierSpacing is information for indicating a subcarrier spacing used in the random access response (message 2).

bfrr-Resources includes RRC parameters bfrr-ssb-ResourceList and/or bfrr-csirs-ResourceList. bfrr-ssb-ResourceList is information (RRC parameter) for indicating a list of parameters BFRR-SSB-Resource for indicating a non-contention based random access resource for a beam failure recovery request corresponding to each of the one or multiple SS blocks transmitted by the base station apparatus 3. bfrr-csirs-ResourceList is information (RRC parameter) for indicating a list of parameters BFRR-CSIRS-Resource for indicating a non-contention based random access resource for a beam failure recovery request corresponding to each of the one or multiple CSI-RSs transmitted by the base station apparatus 3.

BFRR-SSB-Resource includes RRC parameters ssb, ra-PreambleIndex, and/or ra-Resources. ssb indicates the index (SSB-ID) of the SS block to which the parameters included in BFRR-SSB-Resource correspond. ra-PreambleIndex indicates an index of a non-contention based random access preamble associated with a corresponding SSB-ID. ra-Resources indicates a time/frequency resource (which may be a random access occasion) used for transmission of a non-contention based random access preamble associated with a corresponding SSB-ID.

BFRR-CSIRS-Resource includes RRC parameters csirs, ra-PreambleIndex, and/or ra-Resources. csirs indicates an index (CSIRS-ID) of the CSI-RS to which the parameter included in BFRR-CSIRS-Resource corresponds. ra-PreambleIndex indicates an index of a non-contention based random access preamble for a beam failure recovery request associated with a corresponding CSIRS-ID. ra-Resources indicates a time/frequency resource (which may be a random access occasion) used for transmission of a non-contention based random access preamble for a beam failure recovery request associated with a corresponding CSIRS-ID.

In a case that the terminal apparatus 1 performs non-contention based random access for a beam failure recovery request, the terminal apparatus 1 can identify the time/frequency resource for transmitting the index of the non-contention based random access preamble and/or the random access preamble associated with each SS block or CSI-RS, based on the information in RACH-Config-BFRR illustrated in FIG. 11.

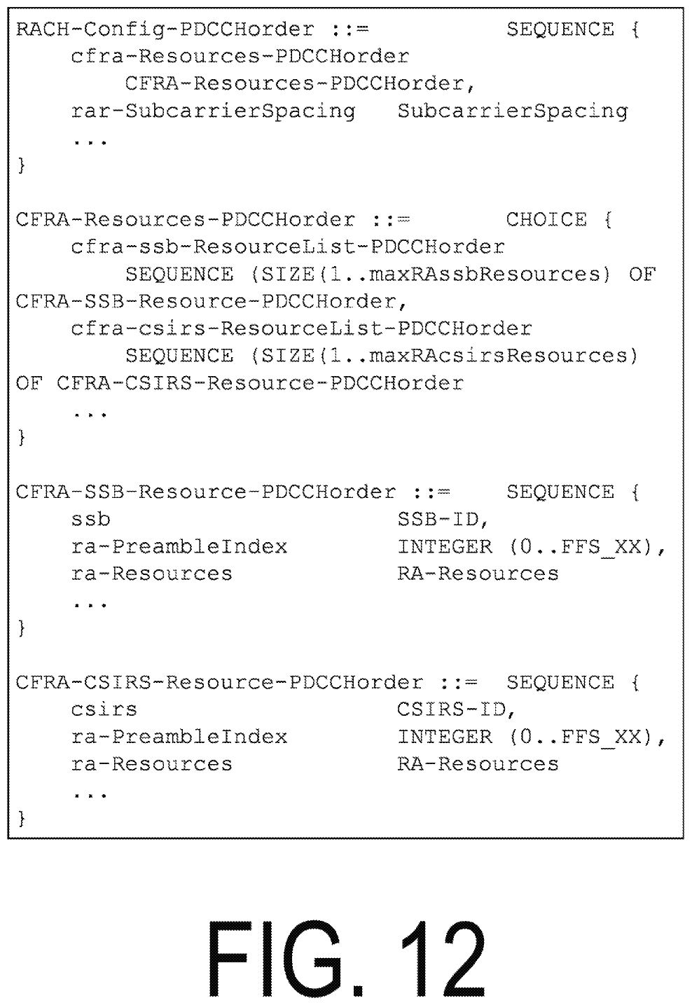

FIG. 12 is a diagram illustrating an example of a configuration of an RRC parameter RACH-Config-PDCCHorder transmitted from the base station apparatus 3 to the terminal apparatus 1 according to the present embodiment. RACH-Config-PDCCHorder is information for indicating a PDCCH order random access configuration (random access resource) configured for each terminal apparatus 1, and is used in a case that the PDCCH order is received from the base station apparatus 3 and/or in a case that information included in the PDCCH order satisfies a prescribed condition. In FIG. 12, RACH-Config-PDCCHorder includes cfra-Resources-PDCCHorder and/or rar-SubcarrierSpacing. cfra-Resources-PDCCHorder is information for indicating a resource configuration for performing a non-contention based random access procedure indicated by the PDCCH order. rar-SubcarrierSpacing is information for indicating a subcarrier spacing used in the random access response (message 2).

cfra-Resources-PDCCHorder includes RRC parameters cfra-ssb-ResourceList-PDCCHorder and/or cfra-csirs-ResourceList-PDCCHorder. cfra-ssb-ResourceList-PDCCHorder is information (RRC parameter) for indicating a list of parameters CFRA-SSB-Resource-PDCCHorder for indicating a non-contention based random access resource corresponding to each of one or multiple SS blocks transmitted by the base station apparatus 3. cfra-csirs-ResourceList-PDCCHorder is information (RRC parameter) for indicating a list of parameters CFRA-CSIRS-Resource-PDCCHorder for indicating a non-contention based random access resource corresponding to each of the one or multiple CSI-RSs transmitted by the base station apparatus 3.

CFRA-SSB-Resource-PDCCHorder includes RRC parameters ssb, ra-PreambleIndex, and/or ra-Resources. ssb indicates the index (SSB-ID) of the SS block to which the parameters included in CFRA-SSB-Resource-PDCCHorder correspond. ra-PreambleIndex indicates an index of a non-contention based random access preamble associated with a corresponding SSB-ID. However, there may be multiple indexes of the non-contention based random access preamble indicated by CFRA-SSB-Resource-PDCCHorder. For example, CFRA-SSB-Resource-PDCCHorder may include a parameter for indicating a preamble group. The terminal apparatus may determine one ra-PreambleIndex from the preamble group indicated by CFRA-SSB-Resource-PDCCHorder, based on information (for example, offset information) included in the PDCCH order. ra-Resources indicates a time/frequency resource (which may be a random access occasion) used for transmission of a non-contention based random access preamble associated with a corresponding SSB-ID.

CFRA-CSIRS-Resource-PDCCHorder includes RRC parameters csirs, ra-PreambleIndex, and/or ra-Resources. csirs indicates an index (CSIRS-ID) of the CSI-RS to which the parameter included in CFRA-CSIRS-Resource-PDCCHorder corresponds. ra-PreambleIndex indicates an index of a non-contention based random access preamble associated with a corresponding CSIRS-ID. However, there may be multiple indexes of the non-contention based random access preamble indicated by CFRA-CSIRS-Resource-PDCCHorder. For example, CFRA-CSIRS-Resource-PDCCHorder may include a parameter for indicating a preamble group. The terminal apparatus 1 may determine one ra-PreambleIndex from the preamble group indicated by CFRA-CSIRS-Resource-PDCCHorder, based on information (for example, offset information) included in the PDCCH order. ra-Resources indicates a time/frequency resource (which may be a random access occasion) used for transmission of a non-contention based random access preamble associated with a corresponding CSIRS-ID.

In a case that the terminal apparatus 1 is indicated to perform non-contention based random access by the PDCCH order from the base station apparatus 3, and the RACH-Config-PDCCHorder is received in the RRC message, the terminal apparatus 1 may be configured to, based on the information included in the PDCCH order and the information included in RACH-Config-PDCCHorder, select the index of the non-contention based random access preamble and/or the time/frequency resource for transmitting the random access preamble (which may be the RACH occasion), and transmit the random access preamble corresponding to the selected index in the selected time/frequency resource.

However, in a case that the terminal apparatus 1 receives one or multiple reference signals (SS block and/or CSI-RS), is indicated to perform non-contention based random access by the PDCCH order, and receives RACH-Config-PDCCHorder in the RRC message, the terminal apparatus 1 may select one of the one or multiple reference signals, and based on the information included in the PDCCH order and the information included in RACH-Config-PDCCHorder, select the index of the non-contention based random access preamble associated with the selected reference signal and/or the time/frequency resource for transmitting the random access preamble (which may be the RACH occasion), and transmit the random access preamble corresponding to the selected index in the selected time/frequency resource.

In a case that the base station apparatus 3 transmits RACH-Config-PDCCHorder in the RRC message to the terminal apparatus 1, and indicates the terminal apparatus 1 to perform non-contention based random access by the PDCCH order, the base station apparatus 3 may receive random access preamble transmitted from the terminal apparatus, based on the information included in the PDCCH order and the information included in RACH-Config-PDCCHorder.

In a case that the base station apparatus 3 transmits RACH-Config-PDCCHorder in the RRC message to the terminal apparatus 1, and indicates the terminal apparatus 1 to perform non-contention based random access by the PDCCH order, the base station apparatus 3 may identify/monitor the time/frequency resource used in the random access preamble transmitted from the terminal apparatus and/or the index of the random access preamble, based on the information included in the PDCCH order and the information included in RACH-Config-PDCCHorder.

Note that, in a case that, to the terminal apparatus 1, the base station apparatus 1 transmits one or multiple reference signals (SS block and/or CSI-RS), transmits RACH-Config-PDCCHorder in the RRC message, and indicates to perform non-contention based random access by the PDCCH order, the base station apparatus 1 may identify one of the one or multiple reference signals, based on the received random access preamble, the information included in the PDCCH order, and/or the information included in RACH-Config-PDCCHorder.

Note that, selecting (reselecting) a reference signal (which may be an SS block or a CSI-RS) may be included as a condition for using the information of RACH-Config-PDCCHorder, in a case that the terminal apparatus 1 performs non-contention based random access, based on the information included in the PDCCH order.

Note that, the RRC parameters RACH-ConfigDedicated, RACH-Config-BFRR, and/or RACH-Config-PDCCHorder illustrated in FIG. 10, FIG. 11, and FIG. 12 are configured independently of each other, but may have the same value. Alternatively, the RRC parameters RACH-ConfigDedicated, RACH-Config-BFRR, and/or RACH-Config-PDCCHorder illustrated in FIG. 10, FIG. 11, and FIG. 12 may be shared parameters. For example, the RRC parameter and/or the random access configuration used in a case that the terminal apparatus 1 is indicated to perform non-contention based random access by the PDCCH order and satisfies a prescribed condition may be the same as the RRC parameter and/or the random access configuration used in a case that the terminal apparatus 1 performs non-contention based random access for the beam failure recovery request. For example, the preamble index and/or the frequency/time resource used to transmit the random access preamble by the terminal apparatus 1 that is indicated to perform non-contention based random access by the PDCCH order may be the same as the preamble index and/or the frequency/time resource used to transmit the random access preamble in the random access procedure for the beam failure recovery request by the terminal apparatus 1.

Although the RRC parameters CFRA-SSB-Resource, CFRA-CSI-RS-Resource, BFRR-SSB-Resource, BFRR-CSIRS-Resource, CFRA-SSB-Resource-PDCCHorder and CFRA-CSIRS-Resource-PDCCHorder illustrated in FIG. 10, FIG. 11, and FIG. 12 are described as including a single ra-PreambleIndex, CFRA-SSB-Resource-PDCCHorder and CFRA-CSIRS-Resource-PDCCHorder can include information related to the preamble index in the PDCCH order, and thus may be configured as information for indicating a selectable range.

For example, CFRA-SSB-Resource-PDCCHorder includes RRC parameters ssb, startIndexRA-Preamble, numberOfRA-Preambles, and/or ra-Resources. ssb indicates the index (SSB-ID) of the SS block to which the parameters included in CFRA-SSB-Resource-PDCCHorder correspond. startIndexRA-Preamble indicates a start index (PreambleStartIndex) of a PDCCH order random access preamble group associated with a corresponding SSB-ID. numberOfRA-Preamble indicates the total number of PDCCH order random access preambles associated with the corresponding SSB-ID. ra-ResourcesPDCCH indicates a time/frequency resource (which may be a random access occasion) used for transmission of the PDCCH order preamble associated with the corresponding SSB-ID. In this case, ra-PreambleIndex may be provided as information included in the PDCCH order.

For example, CFRA-CSIRS-Resource-PDCCHorder includes RRC parameters csirs, startIndexRA-Preamble, numberOfRA-Preambles, and/or ra-Resources. csirs indicates an index (CSIRS-ID) of the CSI-RS to which the parameter included in CFRA-CSIRS-Resource-PDCCHorder corresponds. startIndexRA-Preamble indicates a start index (PreambleStartIndex) of a PDCCH order random access preamble group associated with a corresponding CSIRS-ID. numberOfRA-Preamble indicates the total number of PDCCH order random access preambles associated with the corresponding CSIRS-ID. ra-ResourcesPDCCH indicates a time/frequency resource (which may be a random access occasion) used for transmission of the PDCCH order preamble associated with the corresponding CSIRS-ID. In this case, ra-PreambleIndex may be provided as information included in the PDCCH order (for example, preamble index information).

A selection rule will be described for a case that the terminal apparatus 1 according to the present embodiment receives multiple pieces of random access configuration information, and select one piece of random access configuration information to be used in the random access procedure from the multiple pieces of random access configuration information.

The terminal apparatus 1 may select, the random access configuration information to be used for the random access procedure, based on the channel characteristics between the terminal apparatus 1 and the base station apparatus 3. The terminal apparatus 1 may select the random access configuration information to be used for the random access procedure, based on a channel characteristic (which may be, for example, a reference signal received power (RSRP)) measured by a reference signal received from the base station apparatus 3 (for example, an SS block and/or a CSI-RS).

The terminal apparatus 1 may randomly select one piece of random access configuration information from the received multiple pieces of random access configuration information.

The terminal apparatus 1 may select one piece of random access configuration information from the received multiple pieces of random access configuration information, based on the downlink signal received from the base station apparatus 3. However, the downlink signal may be received from the base station apparatus 3 to which the random access preamble is transmitted, or may be received from a different base station apparatus 3. For example, the random access configuration information selected based on the downlink signal from the first base station apparatus 3 forming the first cell may be used in a random access procedure with the second base station apparatus 3 forming the second cell.

As one or multiple available RACH occasions included in the random access configuration information, a subcarrier index, a resource block index, a subframe number, a system frame number, a symbol number, and/or a preamble format capable of transmitting the random access preamble may be configured.

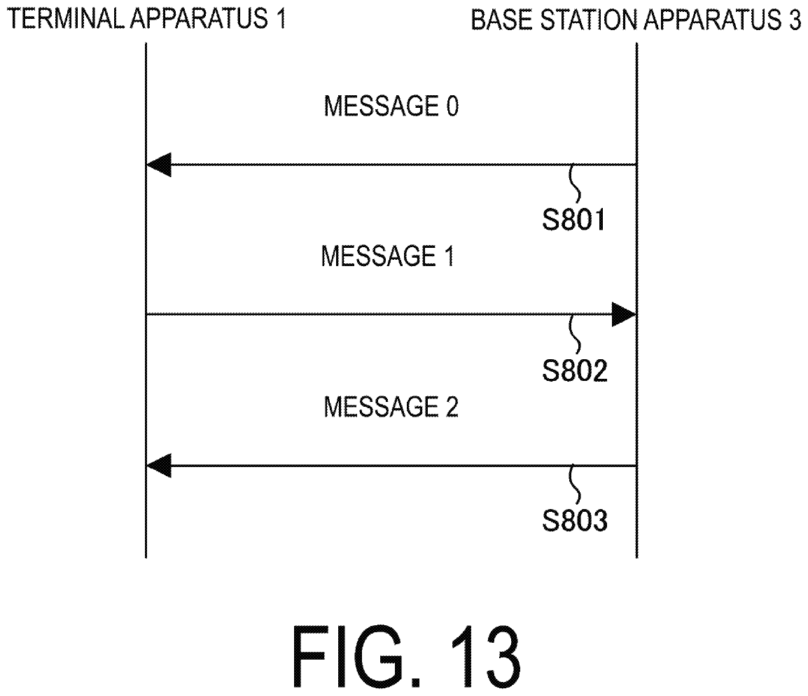

The random access procedure in a case that the terminal apparatus 1 receives message 0 from the base station apparatus 3 is achieved by transmitting and/or receiving multiple messages between the terminal apparatus 1 and the base station apparatus 3, as illustrated in FIG. 13.

### Message 0 (S801)

The base station apparatus 3 allocates one or multiple non-contention based random access preambles to the terminal apparatus 1 by way of a downlink dedicated signalling (also referred to as message 0 or Msg 0). However, the non-contention based random access preamble may be a random access preamble that is not included in the set notified by the broadcast signaling. In a case of transmitting multiple reference signals, the base station apparatus 3 may allocate multiple non-contention based random access preambles corresponding to each of at least some of the multiple reference signals to the terminal apparatus 1.

Message 0 may be indication information for indicating an initiation of a random access procedure from the base station apparatus 3 to the terminal apparatus 1. Message 0 may be a handover (HO) command generated by the target base station apparatus 3 and transmitted by the source base station apparatus 3 for handover. Message 0 may be an SCG change command transmitted by the base station apparatus 3 in order to change the Secondary Cell Group (SCG). The handover command and the SCG change command are also referred to as synchronization reconfiguration. This synchronization reconfiguration (such as reconfiguration with sync) is transmitted in an RRC message. The synchronization reconfiguration is used for an RRC reconfiguration (such as a handover command) with synchronization to the PCell and an RRC reconfiguration (such as an SCG change command) with synchronization to the PSCe1l. Message 0 may be transmitted on the RRC signal and/or the PDCCH. Message 0 transmitted on the PDCCH may be referred to as the PDCCH order. The PDCCH order may be transmitted in DCI in a certain DCI format. Message 0 may include information to allocate a non-contention based random access preamble.

The bit information notified in message 0 may include preamble index information, mask index information, SRS Resource Indicator (SRI) information, reference signal selection indication information (Reference Signal Selection Indicator), random access configuration selection indication information (Random Access Configuration Selection Indicator), RS type selection indication information, single/multiple message 1 transmission identification information (Single/Multiple Msg. 1 Transmission Indicator), and/or TCI.

The preamble index information is information for indicating one or multiple preamble indexes used in the generation of the random access preamble. However, in a case that the preamble index information is a prescribed value, the terminal apparatus 1 may randomly select one of the one or multiple random access preambles available in a contention based random access procedure.

The mask index information is information for indicating an index of time/frequency resources available for transmission of the random access preamble. However, the time resource and/or frequency resource indicated by the mask index information may be a specific resource or may indicate multiple selectable resources, or a different index may indicate each of a specific resource and multiple selectable resources. The mask index information may be information for indicating a portion of the available time/frequency resource defined by prach-ConfigurationIndex. The mask index information may be information for indicating a portion of the available time/frequency resource defined by ra-ResourcesPDCCH. In a case of message 0 transmitted in the RRC, ra-Resources is provided as information corresponding to the mask index information, but in a case of the PDCCH order, ra-Resources may be provided by the PDCCH order. In other words, the mask index information may be referred to as a ra-Resources.

However, the preamble index information and the mask index information may be indicated by one index information. For example, a preamble (which may be referred to as a sequence, code, or the like), or all or a portion of the time resource and the frequency resource available for the terminal apparatus 1 to transmit the random access preamble may be indicated with one index.

However, the preamble index information and/or the mask index information may be configured with different values for each SS block. For example, the terminal apparatus 1 may select one of the one or multiple received SS blocks, and transmit the random access preamble by using the preamble index information and/or the mask index information associated with the selected SS block.

However, common values may be configured for the preamble index information and/or the mask index information in multiple SS blocks. For example, the terminal apparatus 1 may select one of the one or multiple received SS blocks, select the random access configuration associated with the selected SS block, and transmit the random access preamble corresponding to the received preamble index information and/or the mask index information, for an available preamble and/or a time/frequency resource.

The SRI information is information for notifying at least some of the induces of the one or multiple SRS transmission resources configured by the base station apparatus 3. However, the SRI information may be bitmap information corresponding to one or multiple SKS transmission resources configured by the base station apparatus 3.

The terminal apparatus 1 may determine, based on the received SRI information, an antenna port for transmitting the random access preamble. However, in a case that the SRS transmission resources indicated by the SRI information is multiple, the terminal apparatus 1 may transmit the random access preamble on each of multiple antenna ports based on the multiple SRS transmission resources. However, the terminal apparatus 1 may use the antenna port associated with the SRS transmission resource indicated by the SRI information as an antenna port available for transmission and retransmission of the random access preamble. The terminal apparatus 1 may transmit the random access preamble on an uplink transmission beam (transmission spatial filter configuration) associated with the SRS transmission resource indicated by the SRI information. However, the antenna port used for the transmission of the random access preamble by the terminal apparatus 1 receiving the SRI information in message 0 may be QCL with the antenna port associated with the SRS transmission resource indicated by the SRI information.

The reference signal selection indication information is information for indicating whether or not a reference signal (for example, SS block and/or CSI-RS) used for performing a random access procedure is selected for the terminal apparatus 1 that has received message 0. In other words, the reference signal selection indication information may be information for indicating whether or not to select a reference signal, based on the measurement of one or multiple reference signals. However, in a case that the terminal apparatus 1 has already selected one reference signal before receiving message 0, the reference signal selection indication information may be information for indicating whether or not to reselect a reference signal, based on the measurement of one or multiple reference signals. In a case that the reference signal selection indication information indicates to select a reference signal, a reference signal may be selected from among zero, one, or multiple SS blocks and zero, one, or multiple CSI-RSs. However, the reference signal selection indication information may be separately indicated for selection by the type of reference signal (SS block, CSI-RS). For example, the reference signal selection indication information may include SS block selection indication information for indicating whether or not to select one SS block from one or multiple SS blocks and CSI-RS selection indication information for indicating whether or not to select one CSI-RS from one or multiple CSI-RSs. In a case that “no selection” is indicated in the reference signal selection indication information, a reference signal may be selected based on the information of message 0 and/or the reference signal associated with the PDCCH in which message 0 is received. However, in an embodiment in which message 0 does not include the reference signal selection indication information, the terminal apparatus 1 may select a reference signal, based on the information of message 0 and/or the reference signal associated with the PDCCH in which message 0 has been received. As another example, in an embodiment in which the reference signal selection indication information is not included in message 0, the reference signal selection processing may be performed as long as the reference signal and the random access resource are associated with the RRC parameter.

In a case that the reference signal selection indication information is indicated by message 0, the terminal apparatus 1 may monitor one or multiple reference signals, and transmit the random access preamble by using the random access configuration associated with the one selected reference signal.

However, the information indicated by the reference signal selection indication information may be indicated by other information indicated by message 0. For example, the information indicated by the reference signal selection indication information may be included in the preamble index information. The terminal apparatus 1 may select one reference signal from one or multiple reference signals in a case that the preamble index indicated by message 0 is a prescribed value.

The random access configuration selection indication information is information for indicating whether or not to select (reselect) the random access configuration information used to perform the random access procedure, for the terminal apparatus 1 that has received message 0. The terminal apparatus 1 that has received the random access configuration selection indication information in message 0 may select one of the one or multiple pieces of random access configuration information received in the downlink signal, and transmit the random access preamble, based on the selected random access configuration information.

However, the information indicated by the random access configuration selection indication information may be indicated by other information indicated by message 0. For example, the information indicated by the random access configuration selection indication information may be included in the preamble index information. The terminal apparatus 1 may select (reselect) the random access configuration information in a case that the preamble index indicated by message 0 is a prescribed value.

However, in a case that the terminal apparatus 1 selects (reselects) a reference signal to be used for transmission of the random access preamble, based on the information indicated in message 0 (for example, the preamble index information and/or the reference signal selection indication information), the terminal apparatus 1 may specify (determine) the preamble index of the random access preamble and/or the time/frequency resource used in the non-contention based random access, based on CFRA-CSIRS-Resource-PDCCHorder configured in the RRC layer.

However, one piece of common index information may be used for the preamble index information, the SRI information, the reference signal selection indication information, and/or the random access configuration selection indication information. For example, in a case that the common index information is a first value, selection (reselection) of the random access configuration information may be performed, and in a case that the common index information is a second value, one or multiple reference signals may be monitored.

However, the RS type information is information for selecting a type of the reference signal. For example, the RS type information indicates whether message 0 (which may be the PDCCH order) is associated with the SS block or is associated with the CSI-RS. For example, the RS type information indicates whether the random access preamble specified in message 0 (which may be the PDCCH order) is associated with the SS block or is associated with the CSI-RS. For example, the RS type information indicates whether the RACH occasion to be used for the transmission of message 1 by the terminal apparatus receiving message 0 (which may be the PDCCH order) is associated with the SS block or is associated with the CSI-RS.

However, the TCI is a transmission configuration identification (TCI), and one or multiple reference signals associated with the TCI are received by the terminal apparatus 1 from the base station apparatus 3 by the RRC message. One or multiple reference signals associated with the PDCCH used to receive message 0 are identified based on the TCI included in message 0 (which may be the PDCCH order). Alternatively, one or multiple reference signals associated with the PDCCH used to receive message 0 are identified based on the TCI associated with the PDCCH used to receive message 0.

### Message 1 (S802)

The terminal apparatus 1 that has received message 0 transmits the allocated non-contention based random access preamble over the physical random access channel. This transmitted random access preamble may be referred to as message 1 or Msg 1. The random access preamble is configured such that multiple sequences are used for notifying information to the base station apparatus 3. For example, in a case that 64 types of sequence are available, 6-bit information (which may be ra-PreambleIndex or a preamble index) can be provided to the base station apparatus 3. This information is indicated as a Random Access preamble Identifier, and the terminal apparatus 1 can identify message 2 addressed to the terminal apparatus 1 from the base station apparatus 3, by monitoring the random access response (message 2) corresponding to this information. The preamble sequence is selected from the preamble sequence set using the preamble index.

A procedure for selecting a random access resource (including a time/frequency resource and/or a preamble index) in the MAC layer of the terminal apparatus 1 will be described. The terminal apparatus 1 sets the value in the following procedure for the preamble index (which may be referred to as PREAMBLE_INDEX) of the random access preamble to be transmitted.

In a case that (1) a random access procedure is initiated by a notification of a beam failure from a lower layer, (2) a random access resource for non-contention based random access for a beam failure recovery request associated with an SS block or a CSI-RS is provided in the RRC parameter RACH-Config-BFRR, and (3) an RSRP of one or multiple SS blocks or CSI-RSs exceeds a prescribed threshold value, the terminal apparatus 1 selects an SS block or CSI-RS in which the RSRP exceeds the prescribed threshold value, and sets ra-PreambleIndex associated with the selected SS block to the preamble index.

In a case that (1) ra-PreambleIndex is provided in the PDCCH or the RRC, (2) the value of the ra-PreambleIndex is not a value for indicating a contention based random access procedure (for example, 0b000000), and (3) the random access resource for the non-contention based random access is not associated with an SS block or CSI-RS by the RRC, the terminal apparatus 1 sets ra-PreambleIndex to be signaled to the preamble index. 0bxxxxxx means a bit sequence arranged in a 6-bit information field.

In a case that (1) ra-PreambleIndex is provided in the PDCCH or the RRC, (2) the value of the ra-PreambleIndex is not a value for indicating a contention based random access procedure (for example, 0b000000), and (3) the random access resource for the non-contention based random access is not associated with an SS block or CSI-RS by the RRC, or in a case that a “reference signal is not selected” is indicated in the reference signal selection indication information, the terminal apparatus 1 sets ra-PreambleIndex to be signaled to the preamble index.

In a case that (1) the PDCCH order is received from the base station apparatus 3, (2) a random access resource for a non-contention based random access associated with a reference signal (SS block and/or CSI-RS) is provided in the RRC parameter RACH-Config-PDCCHorder, and (3) one or multiple reference signals in which the RSRP exceeds the prescribed threshold value are available among the associated reference signals (SS block and/or CSI-RS), the terminal apparatus 1 selects one of the reference signals (SS block and/or CSI-RS) in which the RSRP exceeds the prescribed threshold value, and sets ra-PreambleIndex associated with the selected reference signal to the preamble index. However, the condition (1) “the PDCCH order is received from the base station apparatus 3” may be limited to a case that the PDCCH order includes reference signal selection indication information for indicating selection of a reference signal. However, the reference signal selection indication information notified by the PDCCH order may be ra-PreambleIndex. For example, a reference signal may be selected in a case that the value of ra-PreambleIndex notified by the PDCCH is a prescribed value (for example, 0b000001).

In a case that (1) an SS block and a random access resource for a non-contention based random access is associated by the RRC, and (2) one or multiple SS blocks in which the RSRP exceeds a prescribed threshold value are available in associated SS blocks, the terminal apparatus 1 selects one of the SS blocks in which the RSRP exceeds the prescribed threshold value, and sets ra-PreambleIndex associated with the selected SS block to a preamble index.

In a case that (1) a CSI-RS and a random access resource for a non-contention based random access is associated by the RRC, and (2) one or multiple CSI-RSs in which the RSRP exceeds a prescribed threshold value are available in associated CSI-RSs, the terminal apparatus 1 selects one of the CSI-RSs in which the RSRP exceeds the prescribed threshold value, and sets ra-PreambleIndex associated with the selected CSI-RS to a preamble index.

The terminal apparatus 1 performs a contention based random access procedure in a case that any of the conditions described above is not satisfied. In a contention based random access procedure, the terminal apparatus 1 selects an SS block having an RSRP of the SS block that exceeds a configured threshold value, and selects a preamble group. In a case that the relationship between the SS block and the random access preamble is configured, the terminal apparatus 1 randomly selects ra-PreambleIndex from the one or multiple random access preambles associated with the selected SS block and the selected preamble group, and sets the selected ra-PreambleIndex to the preamble index.

However, the terminal apparatus 1 may perform a contention based random access procedure in a case that ra-PreambleIndex indicated by message 0 is a prescribed value (for example, 0b000000). However, in a case that ra-PreambleIndex indicated by message 0 is a prescribed value (for example, 0b000000), the terminal apparatus 1 may randomly select one of the one or multiple random access preamble indexes available in the contention based random access.

However, in a case that a mask index is indicated by message 0, the terminal apparatus 1 transmits the random access preamble by using the frequency resource and/or time resource corresponding to the indicated mask index.

However, the terminal apparatus 1 may determine the preamble index of the random access preamble to be used in non-contention based random access, based on ra-PreambleIndex notified in the PDCCH (PDCCH order) and one reference signal selected from one or multiple reference signals. In the RRC layer, an index (ra-PreambleIndex) corresponding to each of the one or multiple reference signals may be associated with the preamble index information notified in message 0.

However, in a case that one SS block is selected and the association between the RACH occasion and the SS block is configured, the terminal apparatus 1 may determine the next available RACH occasion of the RACH occasions associated with the selected SS block. However, in a case that one CSI-RS is selected and the association between the RACH occasion and the CSI-RS is configured, the terminal apparatus 1 may determine the next available RACH occasion of the RACH occasions associated with the selected CSI-RS.

However, the available RACH occasion may be identified based on the mask index information, the resource configuration configured by an RRC parameter, and/or the selected reference signal (SS block or CSI-RS). The resource configuration configured by the RRC parameter includes a resource configuration for each SS block (for example, CFRA-SSB-Resource-PDCCHorder in FIG. 12) and/or a resource configuration for each CSI-RS (for example, CFRA-CSIRS-Resource-PDCCHorder in FIG. 12).

The base station apparatus 3 may transmit the resource configuration for each SS block and/or the resource configuration for each CSI-RS to the terminal apparatus 1 in an RRC message. The terminal apparatus 1 receives the resource configuration for each SS block and/or the resource configuration for each CSI-RS from the base station apparatus 3 in an RRC message. The base station apparatus 3 may transmit the mask index information to the terminal apparatus 1 in message 0. The terminal apparatus 1 acquires the mask index information from the base station apparatus 3 in message 0. The terminal apparatus 1 may select a reference signal (SS block or CSI-RS), based on a condition. The terminal apparatus 1 may identify the next available RACH occasion, based on the mask index information, the resource configuration configured by the RRC parameter, and the selected reference signal (SS block or CSI-RS). The MAC entity in the terminal apparatus 1 may indicates the physical layer to transmit the random access preamble by using the selected RACH occasion.

However, in a case that the SRI configuration information is indicated by message 0, the terminal apparatus 1 transmits one or multiple random access preambles by using an antenna port and/or an uplink transmission beam corresponding to one or multiple SRS transmission resources indicated in the SRI configuration information.

### Message 2 (S803)

The base station apparatus 3 that has received message 1 generates a random access response including an uplink grant for indicating transmission to the terminal apparatus 1, and transmits the generated random access response to the terminal apparatus 1 on the DL-SCH. The random access response may be referred to as message 2 or Msg 2. The base station apparatus 3 calculates an offset in transmission timing between the terminal apparatus 1 and the base station apparatus 3 from the received random access preamble, and includes transmission timing adjustment information (Timing Advance Command) for adjusting the offset in message 2. The base station apparatus 3 includes a random access preamble identifier corresponding to the received random access preamble in message 2. The base station apparatus 3 transmits a Random Access-Radio Network Temporary Identity (RA-RNTI) for indicating a random access response for the terminal apparatus 1 by which the random access preamble has been transmitted, on the downlink PCCH. The RA-RNTI is determined in accordance with the frequency and time positional information of the physical random access channel on which the random access preamble has been transmitted. Here, message 2 (downlink PSCH) may include an index of the uplink transmission beam used for transmission of the random access preamble. The downlink PCCH and/or message 2 (downlink PSCH) may be used to transmit information for determining an uplink transmission beam to be used for transmission of message 3. Here, the information for determining the uplink transmission beam to be used for transmission of message 3 may include information for indicating a difference (adjustment, compensation) from the index of the precoding used for the transmission of the random access preamble.

The terminal apparatus 1 can synchronize with the base station apparatus 3 and perform uplink data transmission to the base station apparatus 3 through the transmission and/or reception of the multiple messages described above.

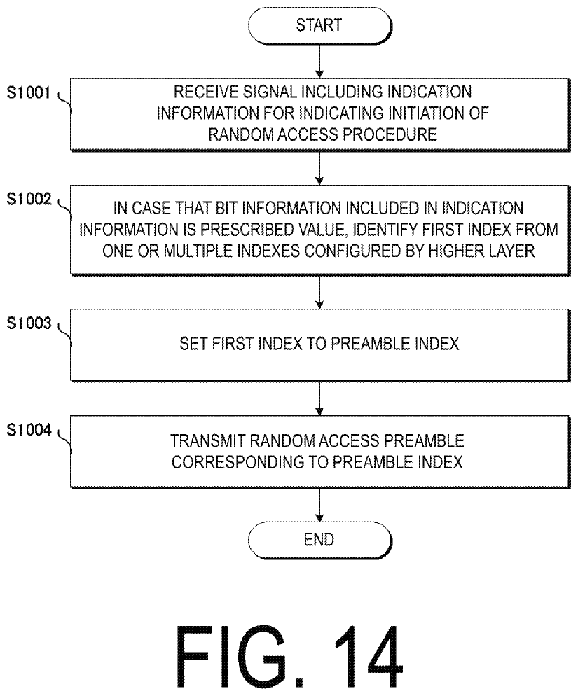

FIG. 14 is a flowchart illustrating an example of a transmission process of a non-contention based random access preamble of the terminal apparatus 1 according to the present embodiment.

The terminal apparatus 1 receives a signal including the indication information (which may be the PDCCH order) for indicating the initiation of the random access procedure from the base station apparatus 3 (S1001). In a case that the bit information included in the received indication information is a prescribed value, the terminal apparatus 1 identifies a first index from one or multiple indexes configured by a higher layer (which may be the RRC layer) (S1002). The terminal apparatus 1 sets the first index to the preamble index. The terminal apparatus 1 transmits the random access preamble corresponding to the preamble index (S1003).

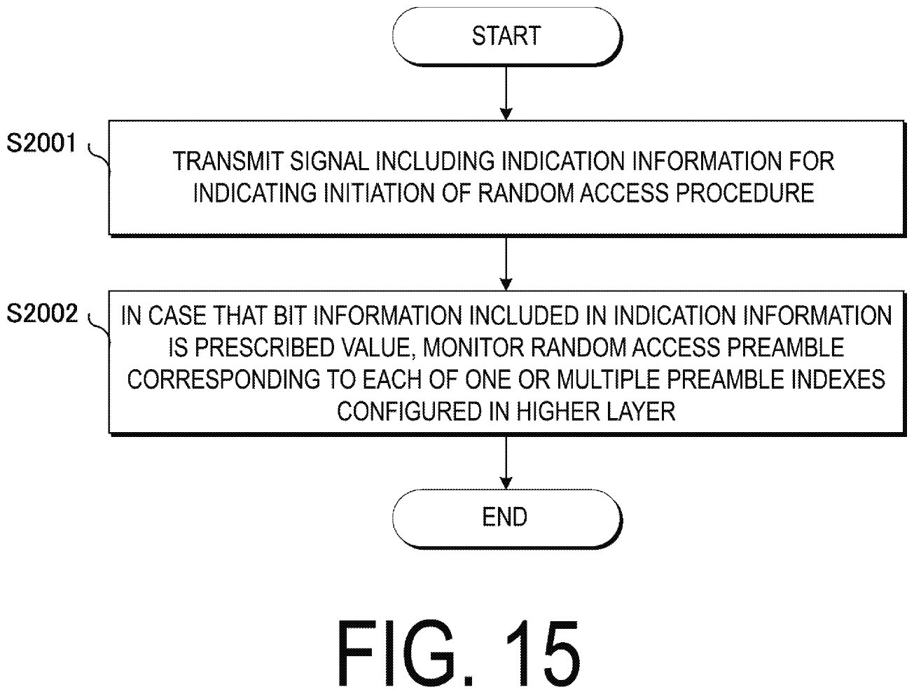

FIG. 15 is a flowchart illustrating an example of a reception process of a non-contention based random access preamble of the base station apparatus 3 according to the present embodiment.

The base station apparatus 3 transmits a signal including the indication information (which may be the PDCCH order) for indicating the initiation of the random access procedure to the terminal apparatus 1 (S2001). In a case that the bit information included in the indication information is a prescribed value, the base station apparatus 3 monitors the random access preamble corresponding to each of the one or multiple preamble indexes configured by a higher layer (which may be the RRC layer) (S2002).

However, the terminal apparatus 1 may receive preamble allocation information for identifying an allocation of randomly selectable indexes (indexes available for contention based random access) corresponding to each of the one or multiple reference signals. However, the terminal apparatus 1 may receive offset information for identifying an offset value from the first index corresponding to each of the one or multiple reference signals. The terminal apparatus 1 may identify the second index, based on the index information, the preamble allocation information, the offset information, and/or the one selected reference signal. The preamble allocation information may be notified in the RRC. The offset information may be notified by the PDCCH.

The preamble allocation information may include information for identifying the RACH occasion allocated to each of the one or multiple reference signals (which may be the indexes of the reference signals, the QCL configurations). The preamble allocation information may include the number (X) of preambles selectable in contention based random access allocated to one reference signal (which may be the index of the reference signal, the QCL configuration). The information of the second information may include the total number (Y) of the preambles available in the contention based random access and the preambles available in the non-contention based random access allocated to one reference signal. The second information may include the number (Z) of reference signals allocated to one RACH occasion. The second information may be notified in the RRC. However, Y may be the interval of the indexes of the preambles that are allocated to each reference signal at equal intervals. For example, in a case that Y is 10 and the first index is 9, the second index for each reference signal may be indicated as 9+10*A. However, A is a value dependent on the correspondence relationship between the reference signal corresponding to the first index and the reference signal selected.

The offset information may include information for identifying the interval of the indexes of the preambles allocated at equal intervals for each reference signal. The offset information may include information for identifying an offset value from the first index corresponding to each reference signal.

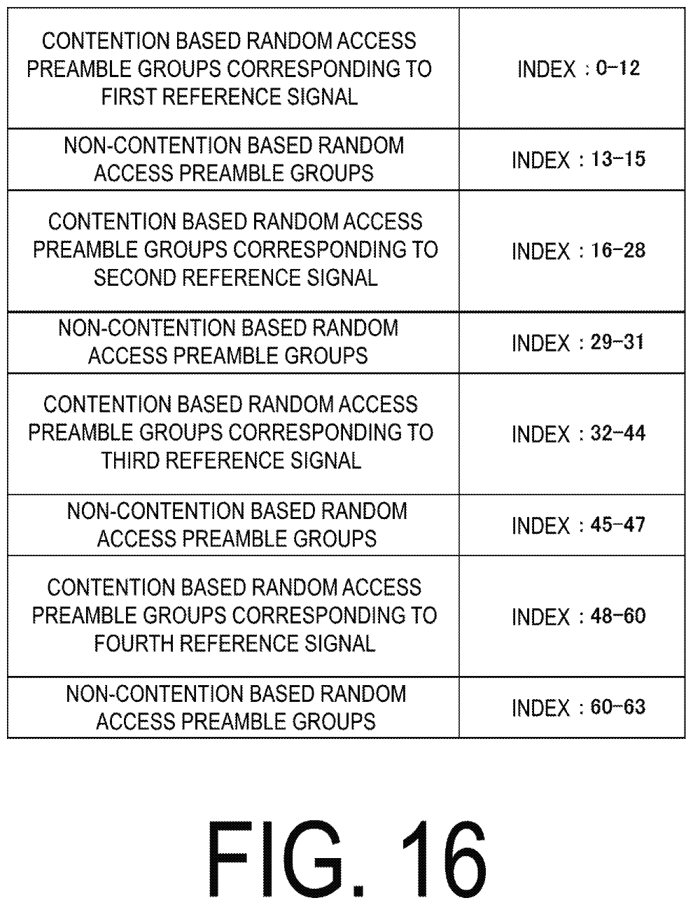

FIG. 16 illustrates an example of an allocation of the preamble indexes. FIG. 16 is an example in which 64 types of indexes 0 to 63 of random access preambles available for a certain RACH occasion are provided, and are classified into preamble groups for contention based random access with respect to four reference signals (for example, SS blocks) and preamble groups for non-contention based random access. In FIG. 16, indexes 0 to 12 are for contention based random access corresponding to a first reference signal; indexes 16 to 28 are for contention based random access corresponding to a second reference signal; indexes 32 to 44 are for contention based random access corresponding to a third reference signal; indexes 48 to 63 are for contention based random access corresponding to a fourth reference signal, and other indexes are for non-contention based random access. However, in the diagram, non-contention based random access preamble groups are allocated between the contention based random access preamble groups corresponding to each reference signal, but may not be allocated in this order. However, in FIG. 16, there are no specific reference signals allocated to the four non-contention based random access preamble groups, but each of non-contention based random preamble groups may be allocated to four reference signals, respectively. However, although FIG. 16 illustrates the allocation of the preamble indexes in one RACH occasion, preamble indexes in multiple RACH occasions may be allocated for multiple reference signals.

The terminal apparatus 1 may be notified with at least some of three pieces of information of X=13, Y=16, Z=4 as preamble allocation information, and identify the allocation such as in FIG. 16.

In a case that 14 is notified as the index information, the terminal apparatus 1 may identify that the index of the non-contention based random access preamble corresponding to the first reference signal is 14. The terminal apparatus 1 may identify, based on the information notified in the index information and the preamble allocation information, an index of a non-contention based random access preamble corresponding to the second reference signal, an index of a non-contention based random access preamble corresponding to the third reference signal, and/or an index of a non-contention based random access preamble corresponding to the fourth reference signal. For example, with Y(=16) as the interval of the indexes of the preambles allocated at equal intervals for each reference signal, the index of the non-contention based random access preamble corresponding to the second reference signal may be identified as 14+16=30, the index of the non-contention based random access preamble corresponding to the third reference signal may be identified as 14+16*2=46, and the index of the non-contention based random access preamble corresponding to the fourth reference signal may be identified as 14+16*3=62. However, 16 may be notified as the interval of the indexes of the preambles allocated at equal intervals for each reference signal by the offset information. However, the offset of the second reference signal with respect to the first index, the offset of the third reference signal with respect to the first index, and/or the offset of the fourth reference signal with respect to the first index may be notified by the offset information, respectively. However, for the indexes included in the four non-contention based random access preamble groups in FIG. 16, non-contention based random access preambles corresponding to multiple reference signals may be allocated in ascending order.

Configurations of apparatuses according to the present embodiment will be described below.

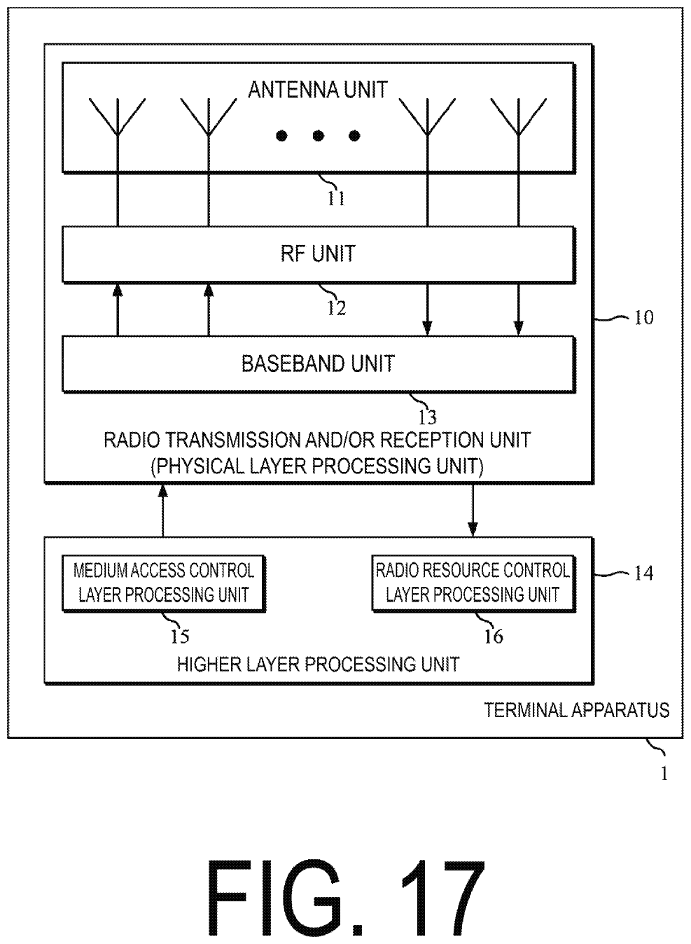

FIG. 17 is a schematic block diagram illustrating a configuration of the terminal apparatus 1 according to the present embodiment. As illustrated, the terminal apparatus 1 includes a radio transmission and/or reception unit 10 and a higher layer processing unit 14. The radio transmission and/or reception unit 10 includes an antenna unit 11, a Radio Frequency (RF) unit 12, and a baseband unit 13. The higher layer processing unit 14 includes a medium access control layer processing unit 15 and a radio resource control layer processing unit 16. The radio transmission and/or reception unit 10 is also referred to as a transmitter, a receiver, a monitor unit, or a physical layer processing unit. The higher layer processing unit 14 is also referred to as a measurement unit, a selection unit, or a controller.

The higher layer processing unit 14 outputs uplink data (which may be referred to as a transport block) generated by a user operation or the like, to the radio transmission and/or reception unit 10. The higher layer processing unit 14 performs some or all of the processings of the Medium Access Control (MAC) layer, the Packet Data Convergence Protocol (PDCP) layer, the Radio Link Control (RLC) layer, and the Radio Resource Control (RRC) layer. The higher layer processing unit 14 may have a function of selecting one reference signal from one or multiple reference signals, based on a measurement value of each reference signal. The higher layer processing unit 14 may have a function of selecting an RACH occasion associated with the selected one of the reference signals from one or multiple RACH occasions. The higher layer processing unit 14 may have a function of identifying one index from one or multiple indexes configured by a higher layer (for example, the RRC layer) and setting the index to the preamble index in a case that the bit information included in the information for indicating the initiation of the random access procedure received by the radio transmission and/or reception unit 10 is a prescribed value. The higher layer processing unit 14 may have a function of identifying an index associated with the selected reference signal from the one or multiple indexes configured by the RRC and setting the index to the preamble index.

The medium access control layer processing unit 15 included in the higher layer processing unit 14 performs processing of the MAC layer (medium access control layer). The medium access control layer processing unit 15 controls transmission of a scheduling request, based on various types of configuration information/parameters managed by the radio resource control layer processing unit 16.

The radio resource control layer processing unit 16 included in the higher layer processing unit 14 performs processing of the RRC layer (radio resource control layer). The radio resource control layer processing unit 16 manages various types of configuration information/parameters of the terminal apparatus 1. The radio resource control layer processing unit 16 sets various types of configuration information/parameters, based on a higher layer signaling received from the base station apparatus 3. Namely, the radio resource control layer processing unit 16 sets the various configuration information/parameters in accordance with the information for indicating the various configuration information/parameters received from the base station apparatus 3.

The radio transmission and/or reception unit 10 performs processing of the physical layer, such as modulation, demodulation, coding, decoding, and the like. The radio transmission and/or reception unit 10 demultiplexes, demodulates, and decodes a signal received from the base station apparatus 3, and outputs the information resulting from the decoding to the higher layer processing unit 14. The radio transmission and/or reception unit 10 generates a transmit signal by modulating and coding data, and performs transmission to the base station apparatus 3. The radio transmission and/or reception unit 10 may have a function of receiving one or multiple reference signals in a cell. The radio transmission and/or reception unit 10 may have a function of receiving information for specifying one or multiple RACH occasions. The radio transmission and/or reception unit 10 may have a function of receiving a signal including indication information for indicating an initiation of a random access procedure. The radio transmission and/or reception unit 10 may have a function of receiving information for receiving information for identifying a prescribed index. The radio transmission and/or reception unit 10 may have a function of receiving information for specifying the index of the random access preamble. The radio transmission and/or reception unit 10 may have a function of transmitting the random access preamble.

The RF unit 12 converts (down converts) a signal received via the antenna unit 11 into a baseband signal by orthogonal demodulation and removes unnecessary frequency components. The RF unit 12 outputs a processed analog signal to the baseband unit.

The baseband unit 13 converts the analog signal input from the RF unit 12 into a digital signal. The baseband unit 13 removes a portion corresponding to the Cyclic Prefix (CP) from the converted digital signal, perforins a Fast Fourier Transform (FFT) of the signal from which the CP has been removed, and extracts a signal in the frequency domain.

The baseband unit 13 generates an OFDM symbol by performing Inverse Fast Fourier Transform (IFFT) of the data, generates an OFDM symbol, adds CP to the generated OFDM symbol, generates a baseband digital signal, and converts the baseband digital signal into an analog signal. The baseband unit 13 outputs the converted analog signal to the RF unit 12.

The RF unit 12 removes unnecessary frequency components from the analog signal input from the baseband unit 13 by using a low-pass filter, up converts the analog signal into a signal of a carrier frequency, and transmits the up-converted signal via the antenna unit 11. Furthermore, the RF unit 12 amplifies power. The RF unit 12 may include a function to determine the transmit power of the uplink signal and/or the uplink channel transmitted in the serving cell. The RF unit 12 is also referred to as a transmit power control unit.

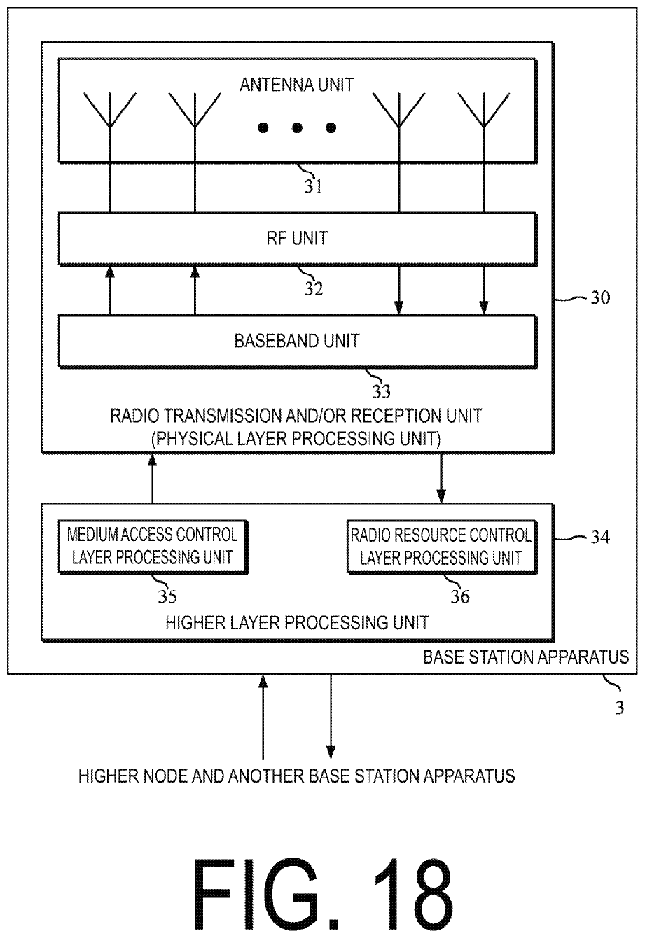

FIG. 18 is a schematic block diagram illustrating a configuration of the base station apparatus 3 according to the present embodiment. As illustrated, the base station apparatus 3 includes a radio transmission and/or reception unit 30 and a higher layer processing unit 34. The radio transmission and/or reception unit 30 includes an antenna unit 31, an RF unit 32, and a baseband unit 33. The higher layer processing unit 34 includes a medium access control layer processing unit 35 and a radio resource control layer processing unit 36. The radio transmission and/or reception unit 30 is also referred to as a transmitter, a receiver, a monitor unit, or a physical layer processing unit. A controller controlling operations of each unit, based on various conditions, may be separately provided. The higher layer processing unit 34 is also referred to as a terminal control unit.

The higher layer processing unit 34 performs processing for some or all of the Medium Access Control (MAC) layer, the Packet Data Convergence Protocol (PDCP) layer, the Radio Link Control (RLC) layer, and the Radio Resource Control (RRC) layer. The higher layer processing unit 34 may have a function of identifying one reference signal from one or multiple reference signals, based on the random access preamble received by the radio transmission and/or reception unit 30.

The medium access control layer processing unit 35 included in the higher layer processing unit 34 performs processing of the MAC layer. The medium access control layer processing unit 35 performs processing associated with a scheduling request, based on various types of configuration information/parameters managed by the radio resource control layer processing unit 36.

The radio resource control layer processing unit 36 included in the higher layer processing unit 34 performs processing of the RRC layer. The radio resource control layer processing unit 36 generates, or acquires from a higher node, downlink data (transport block) allocated on a physical downlink shared channel, system information, an RRC message, a MAC Control Element (CE), and the like, and outputs the generated or acquired data to the radio transmission and/or reception unit 30. The radio resource control layer processing unit 36 manages various types of configuration information/parameters for each of the terminal apparatuses 1. The radio resource control layer processing unit 36 may set various types of configuration information/parameters for each of the terminal apparatuses 1 via higher layer signaling. That is, the radio resource control layer processing unit 36 transmits/reports information for indicating various types of configuration information/parameters. The radio resource control layer processing unit 36 may transmit/broadcast information for identifying a configuration of multiple reference signals in a certain cell.

In a case that the base station apparatus 3 transmits the RRC message, the MAC CE, and/or the PDCCH to the terminal apparatus 1, and the terminal apparatus 1 performs processing, based on the reception, the base station apparatus 3 performs processing (control of the terminal apparatus 1 and the system) assuming that the terminal apparatus is performing the processing. In other words, the base station apparatus 3 transmits, to the terminal apparatus 1, the RRC message, the MAC CE, and/or the PDCCH for causing the terminal apparatus to perform processing, based on the reception.

The radio transmission and/or reception unit 30 has a function to transmit one or multiple reference signals. The radio transmission and/or reception unit 30 may have a function of receiving a signal including a beam failure recovery request transmitted from the terminal apparatus 1. The radio transmission and/or reception unit 30 may have a function of transmitting information for identifying one or multiple RACH occasions to the terminal apparatus 1. The radio transmission and/or reception unit 30 may have a function of transmitting information for specifying a prescribed index. The radio transmission and/or reception unit 30 may have a function of transmitting information for specifying an index of the random access preamble. The radio transmission and/or reception unit 30 may have a function of monitoring the random access preamble in the RACH occasion allocated to each of the one or multiple reference signals. In addition, some functions of the radio transmission and/or reception unit 30 is similar to the functions of the radio transmission and/or reception unit 10, and hence description thereof is omitted. Note that in a case that the base station apparatus 3 is connected to one or multiple transmission reception points 4, some or all of the functions of the radio transmission and/or reception unit 30 may be included in each of the transmission reception points 4.

The higher layer processing unit 34 transmits (transfers) or receives control messages or user data between the base station apparatuses 3 or between a higher network apparatus (MME, S-GW (Serving-GW)) and the base station apparatus 3. Although, in FIG. 18, other constituent elements of the base station apparatus 3, a transmission path of data (control information) between the constituent elements, and the like are omitted, it is apparent that the base station apparatus 3 is provided with multiple blocks, as constituent elements, including other functions necessary to operate as the base station apparatus 3. For example, a Radio Resource Management layer processing unit or an application layer processing unit exist in the higher layer processing unit 34. The higher layer processing unit 34 may also have a function of configuring multiple scheduling request resources corresponding to each of multiple reference signals transmitted from the radio transmission and/or reception unit 30.

Note that “units” in the drawing refer to constituent elements to realize the functions and the procedures of the terminal apparatus 1 and the base station apparatus 3, which are also represented by the terms such as a section, a circuit, a constituting apparatus, a device, a unit, and the like.

Each of the units having the reference signs 10 to 16 included in the terminal apparatus 1 may be configured as a circuit. Each of the units having the reference signs 30 to 36 included in the base station apparatus 3 may be configured as a circuit.

Aspects of the terminal apparatus 1 and the base station apparatus 3 according to the present invention will be described below.

(1) A first aspect of the present invention is a terminal apparatus 1 including: a receiver 10 configured to receive a signal including indication information for indicating an initiation of a random access procedure from a base station apparatus 3; a configuration unit 14 configured to, in a case that bit information included in the indication information is a prescribed value, identify a first index from one or multiple indexes configured in a higher layer, and set the first index to a preamble index; and a transmitter 10 configured to transmit a random access preamble corresponding to the preamble index.

(2) In the first aspect of the present invention, the receiver 10 may receive one or multiple reference signals, and the configuration unit 14 may select one of the one or multiple reference signals and identify a first index, based on the selected reference signal.

(3) In the first aspect of the present invention, one or multiple indexes configured by the higher layer may be used in a random access procedure for a beam failure recovery request.

(4) A second aspect of the present invention is a base station apparatus 3 for communicating with a terminal apparatus 1, the base station apparatus 3 including: a transmitter 30 configured to transmit a signal including indication information for indicating an initiation of a random access procedure to the terminal apparatus 1; and a monitor unit 30 configured to, in a case that bit information included in the indication information is a prescribed value, monitor a random access preamble corresponding to each of one or multiple preamble indexes configured in a higher layer.

(5) In the second aspect of the present invention, the transmitter 30 may transmit one or multiple reference signals, and the monitor unit 30 may identify any one of the one or multiple reference signals, based on the detected random access preamble.

(6) In the second aspect of the present invention, one or multiple indexes configured by the higher layer may be used in a random access procedure for a beam failure recovery request.

(7) A third aspect of the present invention is a terminal apparatus 1 including: a receiver 10 configured to receive an RRC message including information for indicating a PDCCH order random access resource from the base station apparatus 3, and receive a PDCCH order from the base station apparatus; and a transmitter 10 configured to select a random access preamble, based on information included in the PDCCH order, and information for indicating the PDCCH order random access resource, select an RACH occasion, based on information included in the PDCCH order and information for indicating the PDCCH order random access resource, and. transmit the selected random access preamble at the selected RACH occasion.

(8) In the third aspect of the present invention, the information included in the PDCCH order may be information for indicating an index of the random access preamble.

(9) In the third aspect of the present invention, the information included in the PDCCH order may be information for indicating selection of a reference signal.

(10) A fourth aspect of the present invention is a base station apparatus 3 including: a transmitter 30 configured to transmit an RRC message including information for indicating a PDCCH order random access resource to the terminal apparatus 1, and transmit a PDCCH order to the terminal apparatus 1; and a receiver 30 configured to receive a random access preamble based on information included in the PDCCH order and information for indicating the PDCCH order random access resource, at an RACK occasion, based on information included in the PDCCH order and information for indicating the PDCCH order random access resource.

(11) In the fourth aspect of the present invention, the information included in the PDCCH order may be information for indicating an index of the random access preamble.

(12) In the fourth aspect of the present invention, the information included in the PDCCH order may be information for indicating selection of a reference signal.

(13) A fifth aspect of the present invention is a terminal apparatus 1 including: a receiver 10 configured to receive an RRC message including information for indicating an RACH occasion corresponding to one of one or multiple CSI-RSs; and a transmitter 10 configured to, in a case that a reference signal received power of at least one of the one or multiple CSI-RS blocks exceeds a prescribed threshold, select one of the one or multiple CSI-RS blocks with the reference signal received power exceeding the prescribed threshold, select the RACH occasion corresponding to the selected CSI-RS, and transmit a random access preamble in the selected RACH occasion.

(14) A sixth aspect of the present invention is a base station apparatus 3 including: a transmitter 10 configured to transmit an RRC message including information for indicating an RACH occasion corresponding to one of one or multiple CSI-RSs; and a receiver 10 configured to receive a random access preamble in any one of one or multiple of the RACH occasions respectively corresponding to the one or multiple CSI-RSs included in the RRC message.

(15) A seventh aspect of the present invention is a communication method used for a terminal apparatus 1, the communication method including the steps of: receiving an RRC message including information for indicating an RACH occasion corresponding to one of one or multiple CSI-RSs; and in a case that a reference signal received power of at least one of the one or multiple CSI-RS blocks exceeds a prescribed threshold, selecting one of the one or multiple CSI-RS blocks with the reference signal received power exceeding the prescribed threshold, selecting the RACH occasion corresponding to the selected CSI-RS, and transmitting a random access preamble in the selected RACH occasion.

(16) An eighth aspect of the present invention is a communication method used for a base station apparatus 3, the communication method including the steps of: transmitting an RRC message including information for indicating an RACH occasion corresponding to one of one or multiple CSI-RSs; and receiving a random access preamble in any one of one or multiple of the RACH occasions respectively corresponding to the one or multiple CSI-RSs included in the RRC message.

(17) A ninth aspect of the present invention is an integrated circuit mounted on a terminal apparatus 1, the integrated circuit causing the terminal apparatus 1 to perform: receiving an RRC message including information for indicating an RACH occasion corresponding to one of one or multiple CSI-RSs; and in a case that a reference signal received power of at least one of the one or multiple CSI-RS blocks exceeds a prescribed threshold, selecting one of the one or multiple CSI-RS blocks with the reference signal received power exceeding the prescribed threshold, selecting the RACH occasion corresponding to the selected CSI-RS, and transmitting a random access preamble in the selected RACH occasion.

(18) A tenth aspect of the present invention is an integrated circuit mounted on a base station apparatus 3, the integrated circuit causing the base station apparatus 3 to perform: transmitting an RRC message including information for indicating an RACH occasion corresponding to one of one or multiple CSI-RSs; and receiving a random access preamble in any one of one or multiple of the RACH occasions respectively corresponding to the one or multiple CSI-RSs included in the RRC message.

A program running on an apparatus according to the present invention may serve as a program that controls a Central Processing Unit (CPU) and the like to cause a computer to operate in such a manner as to realize the functions of the above-described embodiment according to the present invention. Programs or the information handled by the programs are temporarily stored in a volatile memory such as a Random Access Memory (RAM), a non-volatile memory such as a flash memory, a Hard Disk Drive (HDD), or any other storage device system.

Note that a program for realizing the functions of the embodiments according to the present invention may be recorded in a computer-readable recording medium. This configuration may be realized by causing a computer system to read the program recorded on the recording medium for execution. It is assumed that the “computer system” refers to a computer system built into the apparatuses, and the computer system includes an operating system and hardware components such as a peripheral device. The “computer-readable recording medium” may be any of a semiconductor recording medium, an optical recording medium, a magnetic recording medium, a medium dynamically retaining the program for a short time, or any other computer readable recording medium.

Each functional block or various characteristics of the apparatuses used in the above-described embodiment may be implemented or performed on an electric circuit, for example, an integrated circuit or multiple integrated circuits. An electric circuit designed to perform the functions described in the present specification may include a general-purpose processor, a Digital Signal Processor (DSP), an Application Specific Integrated Circuit (ASIC), a Field Programmable Gate Array (FPGA), or other programmable logic devices, discrete gates or transistor logic, discrete hardware components, or a combination thereof. The general-purpose processor may be a microprocessor or may be a processor of known type, a controller, a micro-controller, or a state machine instead. The above-mentioned electric circuit may include a digital circuit, or may include an analog circuit. In a case that with advances in semiconductor technology, a circuit integration technology appears that replaces the present integrated circuits, it is also possible to use a new integrated circuit based on the technology according to one or more aspects of the present invention.

Note that the invention of the present patent application is not limited to the above-described embodiments. In the embodiment, apparatuses have been described as an example, but the invention of the present application is not limited to these apparatuses, and is applicable to a terminal apparatus or a communication apparatus of a fixed-type or a stationary-type electronic apparatus installed indoors or outdoors, for example, an AV apparatus, a kitchen apparatus, a cleaning or washing machine, an air-conditioning apparatus, office equipment, a vending machine, and other household apparatuses.

The embodiments of the present invention have been described in detail above referring to the drawings, but the specific configuration is not limited to the embodiments and includes, for example, an amendment to a design that falls within the scope that does not depart from the gist of the present invention. Various modifications are possible within the scope of the present invention defined by claims, and embodiments that are made by suitably combining technical means disclosed according to the different embodiments are also included in the technical scope of the present invention. A configuration in which constituent elements, described in the respective embodiments and having mutually the same effects, are substituted for one another is also included in the technical scope of the present invention.

1. A terminal apparatus comprising:
a receiver configured to receive an RRC message including information for indicating an RACH occasion corresponding to one of one or multiple CSI-RSs; and
a transmitter configured to, in a case that a reference signal received power of at least one of the one or multiple CSI-RS blocks exceeds a prescribed threshold, select one of the one or multiple CSI-RS blocks with the reference signal received power exceeding the prescribed threshold, select the RACH occasion corresponding to the selected CSI-RS, and transmit a random access preamble in the selected RACH occasion.

2. A base station apparatus comprising:
a transmitter configured to transmit an RRC message including information for indicating an RACH occasion corresponding to one of one or multiple CSI-RSs; and
a receiver configured to receive a random access preamble in any one of one or multiple of the RACH occasions respectively corresponding to the one or multiple CSI-RSs included in the RRC message.

3. A communication method used for a terminal apparatus, the communication method comprising the steps of:
receiving an RRC message including information for indicating an RACH occasion corresponding to one of one or multiple CSI-RSs; and
in a case that a reference signal received power of at least one of the one or multiple CSI-RS blocks exceeds a prescribed threshold, selecting one of the one or multiple CSI-RS blocks with the reference signal received power exceeding the prescribed threshold, selecting the RACH occasion corresponding to the selected CSI-RS, and transmitting a random access preamble in the selected RACH occasion.

4. A communication method used for a base station apparatus, the communication method comprising the steps of:
transmitting an RRC message including information for indicating an RACH occasion corresponding to one of one or multiple CSI-RSs; and
receiving a random access preamble in any one of one or multiple of the RACH occasions respectively corresponding to the one or multiple CSI-RSs included in the RRC message.

5. An integrated circuit mounted on a terminal apparatus, the integrated circuit causing the terminal apparatus to perform:
receiving an RRC message including information for indicating an RACH occasion corresponding to one of one or multiple CSI-RSs; and
in a case that a reference signal received power of at least one of the one or multiple CSI-RS blocks exceeds a prescribed threshold, selecting one of the one or multiple CSI-RS blocks with the reference signal received power exceeding the prescribed threshold, selecting the RACH occasion corresponding to the selected CSI-RS, and transmitting a random access preamble in the selected RACH occasion.

6. An integrated circuit mounted on a base station apparatus, the integrated circuit causing the base station apparatus to perform:
transmitting an RRC message including information for indicating an RACH occasion corresponding to one of one or multiple CSI-RSs; and
receiving a random access preamble in any one of one or multiple of the RACH occasions respectively corresponding to the one or multiple CSI-RSs included in the RRC message.
